(19) United States
(12) Patent Application Publication
(10) Pub. No.: US 2013/0024676 A1
(43) Pub. Date: Jan. 24, 2013

(54) Control flow integrity

(71) Applicants: Andrew F. Glew, Hillsboro, OR (US); Daniel A. Gerrity, Seattle, WA (US); Clarence T. Tegreene, Bellevue, WA (US)

(72) Inventors: Andrew F. Glew, Hillsboro, OR (US); Daniel A. Gerrity, Seattle, WA (US); Clarence T. Tegreene, Bellevue, WA (US)

(21) Appl. No.: 13/136,024

(22) Filed: Jul. 19, 2011

(51) Int. Cl. G06F 9/38

(52) U.S. Cl. 712/244; 712/E09.06

(57) ABSTRACT

In at least some embodiments, a processor in accordance with the present disclosure is operable to enforce control flow integrity. For examiner, a processor may comprise logic operable to execute a control flow integrity instruction specified to verify changes in control flow and respond to verification failure by at least one of a trap or an exception.

### BACKGROUND

Malicious software, also called “malware,” refers to programming (code, scripts, active content, and other software) designed to disrupt or deny operation, gather information to violate privacy or exploitation, gain unauthorized access to system resources, and enable other abusive behavior. The expression is a general term used by computer professionals to mean a variety of forms of hostile, intrusive, or annoying software or program code.

Malware may also include various software including computer viruses, worms, Trojan horses, spyware, dishonest adware, scareware, crimeware, rootkits, and other malicious and unwanted software or program, and is considered to be malware based on the perceived intent of the creator rather than any particular features. In legal terms, malware is sometimes termed as a “computer contaminant,” for example in the legal codes of one or more U.S. states, such as California.

### SUMMARY

In some embodiments, a processor in accordance with the present disclosure is operable to enforce control flow integrity. For examiner, in at least some embodiments, a processor comprises logic operable to execute a control flow integrity instruction specified to verify changes in control flow and respond to verification failure by at least one of a trap or an exception.

### BRIEF DESCRIPTION OF THE DRAWINGS

Embodiments of the invention relating to both structure and method of operation may best be understood by referring to the following description and accompanying drawings:

FIGS. 1A and 1B are schematic block diagrams depicting an embodiment of a processor that is operable to enforce control flow integrity;

FIGS. 2A and 2B are schematic block diagrams illustrating another embodiment of a processor operable for implementing control flow integrity;

FIGS. 3A and 3B are schematic block diagrams showing an embodiment of an executable logic that can be used to ensure control flow integrity;

FIGS. 4A and 4B is a schematic block diagram showing an embodiment of a data processing apparatus for usage in controlling flow integrity;

FIGS. 5A through 5M are schematic flow charts depicting an embodiment or embodiments of a method for controlling flow integrity in a data processing system; and

FIGS. 6A, 6B, and 6C, a schematic block diagram depicts an embodiment of a data processing apparatus for usage in controlling flow integrity.

### DETAILED DESCRIPTION

In the present document, the term “code integrity” refers to techniques that seek to ensure that code is only used for its designed purpose, and is not exploited by malware.

For example, malware which controls the stack can use return-oriented programming, a technique used to execute code without injecting binary executable code. Code integrity techniques can be implemented to prevent some such ad-hoc and unjustified returns.

Malware can occasionally exploit instruction misalignment to synthesize instruction streams other than those planned by the user. Techniques can be used to prevent instruction misalignment. However, exploits such as return oriented programming are possible even on machines with strict instruction alignment and fixed length instructions.

Exploits can also take advantage of indirect branches in a manner similar to a return (returns are simply indirect branches to a caller IP on the stack), although returns are much more common than indirect branches. Indirect branches are more difficult to exploit since to do so requires, for instance, the ability to violate a stack location which will be loaded into a register used to make an indirect jump.

Attacks on code integrity can take other forms. Terms such as hijacking or code hijacking reflect how attacks on code integrity do not involve code injection, but rather take control of code that is already present.

Disclosed herein are several devices and techniques for preserving code integrity.

Most instructions in program code are not legitimate branch targets, at least not for ordinary control flow such as goto instructions or jumps, indirect jumps, calls, and returns. Although many, if not most or all instructions, may be legitimate targets for returns from interrupts or exceptions, but this special case is usually associated with returning from operating system code in an interrupt handler.

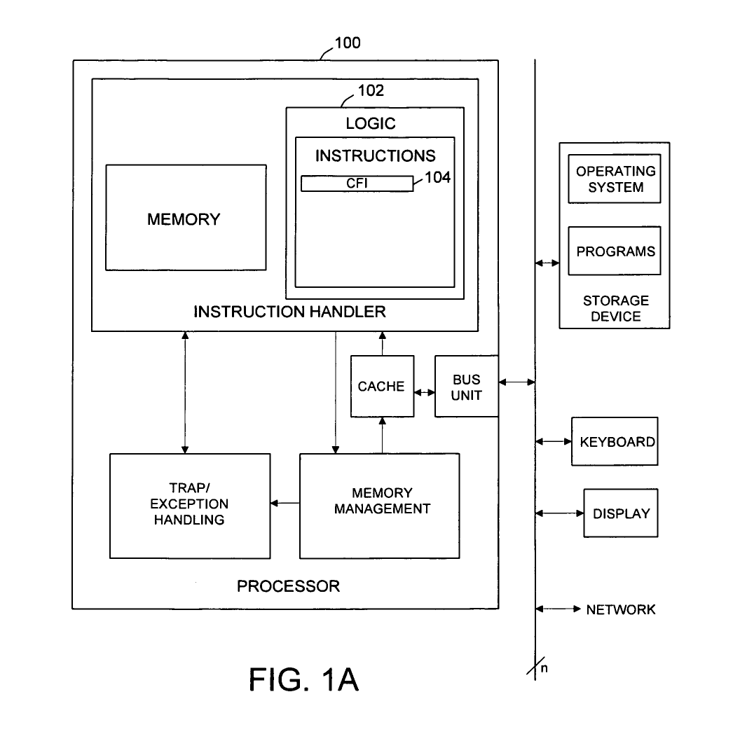

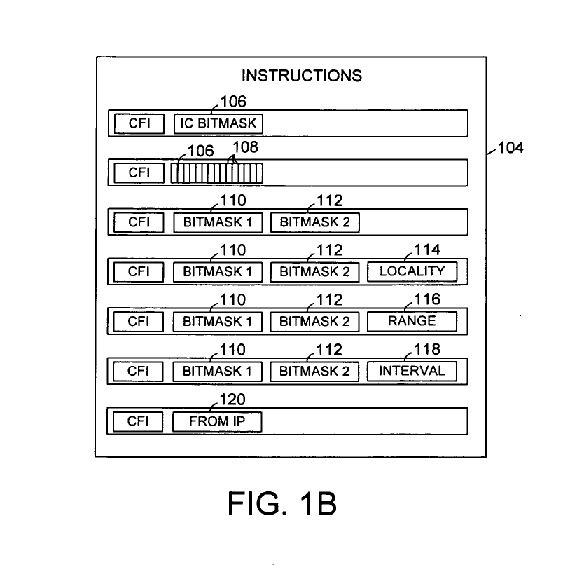

Techniques are disclosed herein for tagging legitimate branch targets. One basic technique for ensuring code integrity involves tagging legitimate branch targets; or, similarly, to distinguish legitimate branch targets from non-legitimate branch targets. Distinction between legitimate branch targets and non-legitimate targets can be made, for example: (a) via a bit in each instruction, and (b) by only allowing the instruction at the branch target to be a special instruction or class of instructions, which may be called a legitimate branch target instruction, such as the control flow integrity instruction 104 as depicted in FIG. 1.

This sort of legitimate branch target instruction is similar to (but not quite) the infamous “come-from” instruction.

Because branch targets are relatively common, using the legitimate branch target instruction on an instruction set with 32-bit fixed-length instructions may be inefficient, but may be acceptable if the instruction set allows 8-bit no-operations (NOPs).

Note that using a NOP from an existing instruction set as a legitimate branch target instruction has the advantage of backward compatibility. For instance, new code annotated in this manner would run on old machines (x86 has a plethora of 8-bit instructions, such as XCHG EBX,EBX).

Distinction between legitimate branch targets and non-legitimate targets can further be made, for example: (c) by using non-adjacent metadata, for example, by creating a datastructure indexed by Instruction Pointer (IP) address, associating metadata with the IP.

Such legitimate branch target metadata can be only a single bit used to indicate that the instruction is permitted to be a branch target (possibly small dense metadata, in the form of a bit per IP). In other configurations, the legitimate branch target metadata can be a longer list, indicating the only IPs that are allowed to branch to the specified location. An example can be sparse or relatively sparse but large metadata, such as a list of branch-from IPs, or classes of IPs.

Any of the existing, well-known forms of memory metadata can be used for the instruction annotations of legitimate branch targets including in-band or out-of-band instruction tags. Additional techniques such as in-band can be enabled because of special circumstances of instruction set design.

In-band tags can include, for example, a bit in each instruction opcode on an instruction set originally designed to include the tags, or specific legitimate branch target instructions. Out-of-band instruction tags can include larger metadata such as a list of branch forms.

Techniques are also disclosed herein for enforcing legitimate branch targets. Enforcement of legitimate branch targets can be performed inline or offline and/or out-of-line.

Inline enforcement can be implemented. For example using a new instruction set can be defined in which a trap occurs if a branch is made to an instruction that is not a legitimate branch target.

Enforcement of legitimate branch targets can also be implemented via an enabling operating mode. For example, an existing instruction set can be modified by creating a mode for legitimate branch target enforcement. By default the mode can be disabled. When enabled, checking can be performed inline, for example by using tags.

An instruction set and associated system that implement a legitimate branch target enforcement mode employ some technique for enabling and disabling the mode. For example, the legitimate branch target enforcement mode can be controlled by appropriate instructions such as ENABLE_LEGITIMATE_BRANCH_TARGET_CHECKING and DISABLE LEGITIMATE BRANCH_TARGET_CHECKING. These instructions can be configured as generic instructions which set a bit in a control register. A desirable capability may be to enable checking inside particular functions near to the function call entry point, and to disable on return from the function. The location of checking by out-of-band metaband can be implicitly indicated, a functionality well-suited to out-of-line checking.

Offline and/or out-of-line enforcement can be implemented. For example, checking can be performed out-of-line by a thread separate from the executing thread.

In some embodiments, legitimate branch targets can be enforced through use of a log-based architecture (LBA), which can be formed by adding hardware support for logging the trace of a main program and supplying the trace to another currently-nonexecuting processor core for inspection. A program running on the second core, called a lifeguard program, executes the desired logging functionality. Log-based architecture lifeguards execute on a different core than the monitored program and increase efficiency since the concurrent programs do not compete for cycles, registers, and memory (cache). Logging by the lifeguards directly captures hardware state and enables capture of the dynamic history of the monitored program.

In an example embodiment, a lifeguard can drive the log record fetch, operating as a set of event handlers, each of which ends by issuing a specialized “next LBA record” instruction, causing dispatch hardware to retrieve the next record and execute the lifeguard handler associated with the specified type of event. Appropriate event values, such as memory addresses of loads and stores, and legitimate branch target tags, are placed in a register file for ready lifeguard handler access. Thus, a particular lifeguard can be used to implement legitimate branch target enforcement.

Any of the disclosed techniques for enforcing or checking legitimate branch target rules can be applied, to any of the forms of legitimate branch target, ranging from simple to more advanced forms. The simple forms disclosed hereinabove include a single-bit tag indicating the instruction either is or is not a legitimate branch target, and a list of legitimate branch-from addresses for a particular legitimate branch target.

Another example of a suitable type of branch target is “local branch only” wherein a target is allowed to be branched-to only by “local” code.

Identifying code as “local” enables x86 segmentation support of near/far memory wherein memory is divided into portions that may be addressed by a single index register without changing a 16-bit segment selector (near), and a real mode or x86 mode with a segment specified as always 64 kilobytes in size. “Local” may be considered to imply IP-relative branches with a limited offset, for example 16-bits.

Still another example of a suitable type of branch target is a “indirect branch target” in which the instruction is or is not allowed to be branched-to by an indirect branch. Typically, most instructions are not allowed to be branched-to. In an example embodiment, the indirect branch target may be accompanied by a list of indirect branch instructions that are allowed to branch to the target. One is often sufficient, although certain optimizations replicate the indirect branch of a CASE statement.

A further example of a suitable type of branch target is a return in which the instruction is or is not allowed to be returned-to.

Any of the techniques such as inline tag or instruction, out-of-line can be used. But the special case of CALL/RETurn permits some optimization. On a fixed length instruction set, the return IP can simply be deprecated by the instruction width, combined with checking for the presence of a CALL instruction. The technique is operable even on variable length instruction sets if the CALL instruction is fixed length. On instruction sets with more pronounced length variability, the calling convention can be redefined to record the IP of the CALL instruction, not the instruction after the CALL. A RETurn instruction can be used to ensure that a CALL instruction is at the correct place, before incrementing the IP to resume execution at the instruction after the CALL.

One disadvantage of CALL and RETurn legitimate branch target arrangements is that techniques to prevent return address stack destruction such as stack shadowing are inapplicable.

A list of places where a RETurn is allowed from can be supported. Also generic indications such as “local” versus “remote” returns can be supported.

Another example of a suitable type of branch target can be a “No-eXecute (NX) bit branch-from” instruction. The NX bit can be used by processors to segregate areas of memory for use by either storage of processor instructions or code for storage of data.

The current instruction can be a legitimate branch target of code that is (or is not) marked as read-only executable code. For example, a default condition can be imposed that branches are only allowed from read-only code. Only instructions that are expected to be branched-to from writable code pages can be marked, for example instructions that are permitted targets for code generation such as self modifying code (SMC).

In an example embodiment, traditional operation of the NX bit can be modified to attain functionality of “from pages marked with the NX bit when NX bit checking is disabled.” In other embodiments, the same functionality can be attained by introducing a new mode.

Still another example of a suitable type of branch target can be a “CALL target” instruction wherein the current instruction is (or is not) allowed to be the target of a CALL.

Any of the disclosed techniques, for example tag bit, special instruction, out-of-band, and the like, can be used with the CALL target, although again, the characteristic of the CALL target as being close to a function call, may impose usage of “standard” special instructions like the x86's ENTER instruction, rather than a new ENTRY POINT instruction.

One aspect of instruction set design is instruction set length and alignment. Considerations taken into account in determining instruction length include whether the instruction set should have fixed length instructions or variable length instructions, and how long the instructions should be.

For example, GNU Compiler Collection (GCC) is a compiler system supporting various programming languages. A group developing a GCC Compiler for an IBM Research Supercomputer selected fixed-length 40-bit instructions on the basis that 32-bit instructions were insufficient for selecting from among 256 registers. Usage of fixed-length instructions enables hardware with simpler decoding circuitry. The program counter (PC) is specified to count instructions rather than bytes and the instructions are a single byte long.

Mid-Instruction Branching

Another aspect of instruction set design is to determine whether to allow branching into the middle of an instruction, a determination that may be considered an instruction alignment issue, related to the data alignment issue for date memory references.

### Strict Instruction Alignment

In a system with strict instruction alignment, instruction sets can impose fixed-length instructions with a length N, requiring all instructions to be on addresses A such that A mod N=0 (on multiples of N).

Strict instruction alignment can be considered to extend to instructions with variable length instructions where all the larger instructions are multiples of all of the smaller instructions, for example an instruction set with 16-bit, 32-bit, and 64-bit instructions. In a specific example, a 16-bit instruction can begin on any even 8-bit boundary, but a 32-bit instruction must begin on a 32-bit boundary, implying that one 16-bit instruction must always be associated with a second 16-bit instruction or a 16-bit NOP to enable a 32-bit instruction to begin. A similar condition applies for 64-bit instructions.

A similar allowable strict instruction alignment instruction set can include 16-bit, 32-bit, and 96-bit instructions, but not have 64-bit instructions.

An example of a strict instruction alignment configuration is the Gould NP1 superminicomputer that imposed strict instruction alignment of 16-bit and 32-bit instructions, that can allow a pair of 16-bit instructions within a 32-bit block to be executed in a superscalar manner.

Most existing instruction sets of mixed 16-bit and 32-bit instructions do not appear to require 32-bit instructions to begin on a 32-bit boundary, except for instruction sets that have 16-bit and 32-bit instruction modes rather than full interleaving of the different instruction sizes.

Strict instruction alignment is essentially a natural alignment, although the term natural alignment is more usually associated with power of two sizes of data, such as 8-bit on any byte boundary, 16-bit on any even byte boundary, 32-bit on any boundary that is a multiple of four, and the like.

### Overlapping Variable Length Instructions

A system can be configured with overlapping variable length instructions. For instruction sets with variable length instructions, or even for fixed-length instructions but where strict instruction alignment is not required, branching into the middle of a valid instruction may be possible, and to find in the middle of a valid instruction a new, different, valid instruction. Thus, any particular contiguous block of instruction bytes may correspond to several possible sets of instructions, depending on where the block is entered. (Note the observation that such instruction sequences often resynchronize after a short time, which has be attributed by Jacob et al. to the Kruskal Count. Refer to Matthias Jacob, Mariusz H. Jakubowski, and Ramarathnam Venkatesan. 2007. Towards integral binary execution: implementing oblivious hashing using overlapped instruction encodings. In Proceedings of the 9th workshop on Multimedia \& security (MM\&\#38;Sec '07). ACM, New York, N.Y., USA, 129-140).

For example, the Intel x86 code sequence:
B8 01 C1 E1 02 90 41,
   corresponds to the instruction:
move ax, C1E10290;
   but also contains the sequence:
C1 E1 02 90 41,
   which corresponds to the instruction:
shl eax, 2; nop,
   if started not at the first but at the third byte.

Overlapping instructions have historically caused problems for disassemblers and decompilers, and have been used as ways of obfuscating code, for example hiding malware or copy protection code. Overlapping instructions have been used to break into code, for example by branching around checking sequences, or in creating little snippets of code to be executing by stack smashing returns.

### Overlapping Non-Strict Fixed Length Instructions

A system can be configured with overlapping non-strict fixed-length instructions. Most instruction set architectures with fixed-length instructions also have strict instruction alignment.

The system disclosed herein suggests extension to instruction sets with a non-strict alignment, for example an instruction set comprising 5-byte, 40-bit instructions.

The program counter (PC) can be operable to contain instruction byte addresses, and strict enforcement is not enforced by requiring that an instruction address be equal to zero mod 5.

The problem can be avoided, for example by having the program counter (PC) contain instructions rather than instruction byte addresses, obtaining the byte addresses by multiplying by 5 (x<<2+x).

However, the problem is not solved since virtual address aliasing may also result in out of synchrony instruction boundaries. Approaches such as requiring strict instruction alignment to a non-power-of-2 may greatly reduce, but cannot eliminate, the frequency of the instruction misalignment in the presence of possible operating system virtual memory misbehavior. For instance, instruction misalignment may be ignored for performance reasons, but not correctness and security.

The problem of instruction misalignment, specifically branching into the middle of an instruction, can be addressed or ignored. Addressing instruction misalignment is desirable because binary translation tools such as Intel Pin are more easily written in the absence of instruction misalignment and such tools can be very useful in performance optimization. A further advantage of preventing instruction misalignment is that strict instruction alignment plus other constraints sometimes facilitates operation of decoded instruction caches. A reason to allow instruction misalignment is that the binary translation tools facilitate movement of binary code to other computing systems, including systems with other instruction set architectures, at the corresponding cost of reduced security.

One condition for facilitating the building of a decoded instruction cache is an instruction set with fixed length instructions and strict alignment of power of two-sized instructions: 16-bits, 32-bits, 64-bits, and so on. This condition may be insufficient in practice. A further condition is that decoding be 1:1 so that a fixed number of instruction bytes or words always produce a fixed number of instructions. The second condition is not always met. Some so-called RISC (Reduced Instruction Set Computer) instructions may naturally be desirably decoded into multiple internal instructions.

A non-1:1 mapping of instruction addresses to decoded instructions substantially increases the difficulty of configuring decoded instruction caches for several reasons including the presence of variable length instructions, instructions with a variable number of decoded microinstructions, and optimizations that remove instructions. Removing a few instructions per line may be easy to handle simply by padding but significant optimizations are more difficult to achieve.

In particular, basic block caches and trace caches present challenges because even if a 1:1 mapping of instructions to micro-operations (uops) exists, the number of instructions and/or uops in a basic block or trace may be variable. Or, if the number of instructions of uops is fixed in such a basic block cache, the number corresponds to a variable, and possibly discontiguous, range of instruction bytes. Instruction address range variability for cache blocks complicates instruction cache snooping.

Instruction misalignment poses different issues for machines with and without a coherent instruction cache. On a machine with an incoherent instruction cache, not only may the instructions being executed be inconsistent with memory, but incoherent copies may be present in the local instruction cache, possibly resulting in even more inconsistent performance than for ordinary lack of coherence. However, similar performance problems can occur with a trace cache, even with fixed-length instructions.

Accordingly, whether instruction misalignment should be addressed has advantages and disadvantages. In practice, microarchitectures that can handle instruction misalignment have been built and have been successful.

One reason to address instruction misalignment is code integrity. Instruction misalignment has often been used by malware. Preventing instruction misalignment can improve security.

Various techniques are disclosed herein for eliminating instruction misalignment. Results attained by applying these techniques can be compared in terms of cost in actual expense and performance.

Instruction encoding can be defined to prevent instruction misalignment.

### Instruction Encodings for Preventing Misalignment

One technique for instruction encoding to prevent instruction misalignment is an in-line tag bit per minimum instruction chunk to indicate the start of an instruction.

In an illustrative example, for an encoding of a 16-bit instruction which appears as:
1xxx_xxxx_xxxx_xxxx.

The encoding of a 32-bit instruction can be:
1yyy_yyyy_yyyy_yyyy 0yyy_yyyy_yyyy_yyyy.

The encoding of a 64-bit instruction can be:
1zzz_zzzz_zzzz_zzzz 0zzz_zzzz_zzzz_zzzz
0zzz_zzzz_zzzz_zzzz 0zzz_zzzz_zzzz_zzzz.

In the illustrative example, in general all instructions are multiples of the minimum instruction chunk size, in the above sample, 16-bits.

Each instruction chunk has a bit that indicates whether the bit is the start of an instruction, in more generality, a multi-bit field or possibly even the entire chunk.

The fields of xs, ys, and zs may disambiguate and thus fully decode to indicate the proper length. Another possibility is that the fields xs, ys, and zs may not disambiguate completely so that one instruction chunk past the end of the current instruction may have to be examined for decoding to find another instruction chunk that is marked as the beginning of an instruction. For the second possibility, requiring a padding instruction indicating the end of the previous instruction may be desired for placement at the end of a code segment, separating code and data.

Usage of instruction encodings to prevent instruction misalignment is advantageous because the techniques are simple.

A disadvantage with usage of instruction encodings to prevent instruction misalignment is that discontiguous instruction fields can result. For example, a 16-bit constant literal inside the instruction would be split into 15-bits and than a single bit.

This disadvantage can be handled by in-instruction size encoding.

For an illustrative example of in-instruction size encoding. An encoding of a 16-bit instruction can appears as:
1xxx_xxxx_xxxx_xxxx.

The encoding of a 32-bit instruction can be:
1yyy_yyyy_yyyy_yyyy 0yyy_yyyy_yyyy_yyyy.

The encoding of a 96-bit instruction can be:
1zzz_zzzz_zzzz_zzzz 0zzz_zzzz_zzzz_zzzz
0zzz_zzzz_zzzz_zzzz 0zzz_zzzz_zzzz_zzzz.

Instruction alignment bits can be collected at the start of the instruction. Let the encoding of a 16-bit instruction appear as:
1xxx_xxxx_xxxx_xxxx.

The encoding of a 32-bit instruction can be:
01yy_yyyy_yyyy_yyyy yyyy_yyyy_yyyy_yyyy.

The encoding of a 64-bit instruction can be:
001z_zzzz_zzzz_zzzz zzzz_zzzz_zzzz_zzzz
zzzz_zzzz_zzzz_zzzz zzzz_zzzz_zzzz_zzzz.

The illustrative encoding use an encoding trick of finding the first set bit to indicate size, permitting extensibility, for example, to 128-bit instructions. The depicted encoding is optional and can be replaced with a more-packed, less-extensible encoding. For example, the encoding of a 16-bit instruction can appear as:
1xxx_xxxx_xxxx_xxxx.

The encoding of a 32-bit instruction can be:
00yy_yyyy_yyyy_yyyy yyyy_yyyy_yyyy_yyyy.

The encoding of a 64-bit instruction can be:
01zz_zzzz_zzzz_zzzz zzzz_zzzz_zzzz_zzzz
zzzz_zzzz_zzzz_zzzz zzzz_zzzz_zzzz_zzzz.

The illustrative encoding has less extensibility. Another example can use a three-bit field for the 32-bit and 64-bit instructions.

However, because the bits that indicate instruction alignment are at the front of an instruction, for branching into an instruction at an address that is something like 2 modulo 4, whether the position corresponds to a 16-bit instruction or the middle of a 32-bit or 64-bit instruction is unclear. To resolve the condition may require looking back in the instruction stream.

A technique for looking back in a strictly-aligned instruction stream may be used.

In a strictly aligned instruction stream, 32-bit instructions are positioned on a 32-bit boundary, and 64-bit instructions are positioned on a 64-bit boundary, and so on. The positioning is most easily attained if instructions are powers of two in size such as 16-bit, 32-bit, 64-bit, or at least are all multiples of all smaller instructions.

Instruction boundaries for each of the instruction sizes can be observed, up to the largest naturally-aligned instruction size. For example, if positioned at a 16-bit boundary, look to the earlier 32-bit and 64-bit boundaries. If positioned at a 32-bit instruction, look to the earlier 64-bit boundary. If positioned at a 64-bit instruction, look no further, since no larger instruction size exists in the example.

For positioning at a 16-bit instruction boundary, and if the 32-bit and 64-bit boundaries observed by looking-back do not indicate existence of a larger overlapping instruction, then the looking-back operation is complete.

A generalized example of the looking-back technique can be described in pseudocode as follows:
Given an instruction pointer IP
If the bitstream at this position decodes to an illegal instruction, stop
If the bitstream at this location decodes to a legal instruction whose size satisfies the alignment, continue
   else stop
For all larger instruction sizes Sz
   look at the earlier Sz-yh boundary (“round down” to a Sz-th boundary)
   If the bitstream at this location decodes to a legal instruction whose size satisfies the alignment of the boundary and whose size would overlap the current instruction
   Then flag an error for the current instruction.
end loop
if arrived here then no instruction alignment error was detected

The illustrative approach does not require explicit fields for instruction size in the instruction, although such fields are convenient.

The technique is suitable so long as the encodings disambiguate, such that:
xxxx_xxxx_xxxx_xxxx,
yyyy_yyyy_yyyy_yyyy yyyy_yyyy_yyyy_yyyy, and
zzzz_zzzz_zzzz_zzzz zzzz_zzzz_zzzz_zzzz
zzzz_zzzz_zzzz_zzzz zzzz_zzzz_zzzz_zzzz.

The encodings disambiguate so long as some bit differences exist between the first 16-bits of the xs and ys and zs, and some bit differences exist between the first 32-bits of the ys and zs, and the like. The encodings disambiguate so long as bit differences exist between any two instructions, within the length of the smallest instruction.

The size fields, such as 1/01/001 or 1/00/01 indicate that fewer bits are observed. The entire instruction need not be decoded.

A technique can be used for looking back in a non-strictly aligned instruction system. For example, assume a mix of 16-bit and 32-bit instructions that are not strictly aligned. A 32-bit instruction can begin on any 16-bit boundary, although 16-bit instructions must begin on 16-bit boundaries.

Encoding of a 16-bit instruction can appear as:
1xxx_xxxx_xxxx_xxxx.

Encoding of a 32-bit instruction can be:
01yy_yyyy_yyyy_yyyy yyyy_yyyy_yyyy_yyyy.

A technique for detecting branching into the middle of the 32-bit instruction depicts actions taken for a branch to an arbitrary location, looking back.

First, determine whether the position is at a legitimate instruction boundary. For an example instruction:
iiii_iiii_iiii_iiii.

The instruction may look like a legitimate instruction, but may turn out to be bits from the middle of a larger, overlapping instruction.

In a simple case, if the instruction looks illegal, stop.

Looking back—16-bits may be seen as:
1hhh_hhhh_hhhh_hhhh,
   which is possibly a 16-bit non-overlapping instruction.

Looking at instruction:
iiii_iiii_iiii_iiii.

The instruction at −16-bit could be a 16-bit instruction indicating a legitimate instruction boundary. Or the instruction could be part of a 32 bit instruction. In the latter case, since no instruction sizes are larger than 32 b, then the instruction boundary is legitimate. Thus, if the instruction at −16-bit is a small instruction that does not overlap, the instruction boundary is legitimate.

Looking back—16-bits may be seen as:
01hh_hhhh_hhhh_hhhh,
   which is possibly a 32-bit overlapping instruction.

Looking at instruction:
iiii_iiii_iiii_iiii.

The instruction at −16-bit could be a 32-bit instruction indicating positioning at an instruction boundary that is not legitimate. Or the instruction could be part of a 32 bit instruction. In the latter case, since no instruction sizes are larger than 32-bit, then the instruction boundary is legitimate.

Looking back—16-bits may be seen as:
1ggg_gggg_gggg_gggg
01hh_hhhh_hhhh_hhhh.

Looking at instruction:
iiii_iiii_iiii_iiii.

If all instruction chunk boundaries look like a possible sequence of possibly overlapping instructions, then no basis to “synchronize” is available. Determining whether the instruction boundary is legitimate is not possible. The problem is lack of ability to determine how far back to look.

Various special techniques can be used to determine legitimacy of instruction boundaries, for example by requiring the compiler to insert a synchronization instruction every N instructions. But in general looking back an arbitrary amount is undesirable. One special technique may be to always ifetch (instruction fetch) the naturally-aligned 128 bits surrounding a 16-bit chunk. But looking backwards across pages or other boundaries is undesirable.

Still another technique for encoding instructions to prevent instruction misalignment is the usage of in-line multiple-instruction templates.

Techniques disclosed hereinabove indicate the operation of in-line tag bits at fine granularity. Other of the disclosed techniques teach how the additional information of strict instruction alignment enables instruction misalignment to be detected, both with and without fields that specify instruction size. But in-line instruction granularity tag bits don't work if an infinite sequence of possibly overlapping instructions precedes the observation position.

To avoid the undesirable action of looking back an arbitrary amount, instruction fetch can be divided into fixed size blocks, for example 128 bits. All instruction fetch can be configured to fetch this large a block, even though branching to an instruction inside the block, and not at the beginning of the block, is possible. Or, at least, the location inside the block being branched-to is fetched, plus a few more bits possibly elsewhere in the block.

The block can be operable as a template, with a few bits at a well known place in the large block (for example 128 bits), indicating instruction boundaries.

An example can be used to explain operation of the in-line multiple-instruction templates. The example template is specified in the form of 128-bit blocks. Instructions that are a multiple of 16-bits, such as 16-bits and 32-bits, are allowable although the example can also handle 48-bit, 64-bit, 96-bit, 128-bit, and the like instructions. The 0th 16-bit chunk of the block can be reserved for block template bits. Other aligned 16-bit chunks of the block can contain instruction data. Eight 16-bit chunks can be in the block—actually seven, since the least significant chunk is occupied by the template. A bitmask can be specified as follows: bits 1 to 7, indicating an instruction boundary. For example, bit i being set can mean branching to chunk I is permitted, or to start decoding at chunk i. The illustrative configuration is more than sufficient to accomplish the purpose of detecting misalignment since only 7 bits of the 16 available by reserving the entire 0th chunk are used.

Other examples can specify more information in the template. For example, a bit can be used to specify whether “falling through” from a previous instruction block into the current block is permitted. If assumed that such “falling through” is not permitted—if assumed that the first 16-bit chunk in a block is always a new instruction—then only six bits are needed in the mask, rather than seven.

The large number of free bits enables use for other purposes such as code integrity, to indicate legitimate branch targets as well as legitimate instruction boundaries.

For example, a simple encoding can be supported. In chunks 2-6, two bits per chunk can be used for encoding including one bit to indicate a legitimate instruction boundary, and +1 bit to indicate a legitimate branch target. This specification indicates some redundancy since the instruction cannot be a branch target if not an instruction boundary. Another possible tighter encoding example can be: 00 for no instruction boundary, 01 for instruction boundary but not a branch target, 11 for an instruction boundary and branch target, and 10 undefined or reserved for other uses.

In chunk 1, four states can be represented including: 00 for not an instruction boundary which may be part of the instruction in the previous block, 01 for an instruction boundary and not a branch target with fall-through from the previous block allowed, 10 for an instruction boundary and branch target with no fall-through from the previous block allowed, and 11 for an instruction boundary and branch target with fall-through from the previous block allowed.

In chunk 7, the two bits for chunks 2-6 are supplemented by an additional bit to indicate that chunk 7 is the end of an instruction.

In the example, 15 of the 16 available bits are used. Other examples can consolidate the bits more, such as to 13 bits, if found to be useful.

One useful example application that fits in a single block is an i-block (instruction block) legitimate CALL target, with the not unreasonable requirement that functions begin on a i-block boundary. Since CALLs are seldom spoofed, an indirect jump target, with the same alignment requirement, an indirect jump or call, and an indirect call can be implemented using in-line multiple-instruction templates. But a RETurn target, can probably not be implemented since requiring function CALLs have a minimum alignment is likely to onerous, although the CALL might be allowed to be at a non-i-block alignment, but just requiring the RETurn to be aligned to the next i-block boundary.

In the example application, seven 16-bit instruction chunks can be included in a 128-bit instruction block with one chunk per block reserved for a template that describes where instructions begin and end, as well as possible branch targets.

The example application can be generalized, even to non-power-of-two sized instructions. For example, 128-bit instruction blocks can contain either five 24-bit instructions or three 40-bit instructions. One byte per i-block is thus left to use as a template. One-bit or two-bit encodings can be used to distinguish 24-bit from 40-bit instruction sizes. One bit per chunk can be used to indicate a branch target with another bit allocated for fall-through.

A general form can be described as: (a) an instruction stream with instructions that are all a multiple of a given i-chunk size, (b) an i-block with a size equal to several such i-chunks plus extra bits to be used as a template, and (c) the template of the i-chunk describing one, some or all of several characteristics. The template can describe which i-chunks within the i-block are legitimate instruction beginning points, in particular whether the first i-chunk is part of an instruction from the previous i-block in the static code layout, and possibly also whether the last i-chunk terminates or overflows into the next i-chunk. The template can further describe which i-chunks are legitimate instruction branch targets, in particular whether the first chunk can fall through with non-branch execution from the previous i-chunk.

An even more general form can be described as: (a) an instruction stream with instructions of predetermined sizes, but not necessarily multiples of an i-chunk size larger than a single bit, (b) an i-block with a size sufficiently large to contain several such instructions plus extra bits to be used as a template, and (c) the template indicating the sizes and/or boundaries of instructions within the i-block.

The concept of a template reflects some aspects of VLIW instruction sets and is extended for use for sequential, non-VLIW, instruction encoding. In the illustrative example, templates can be used for instruction encoding of sequential instructions without the explicitly parallel bits used to control VLIW.

The template approach adds several aspects to the instruction set including: (a) branching is made to i-block number or the instruction number in the i-block, rather than an address, and (b) for branching to an address, the chunk that holds the template is jumped-over.

One approach allows any multiple of 16-bit instructions to be used, rather than restriction to an i-block of all the same instruction size.

### Out-of-Line Metadata

Out-of-line metadata can be used to detect legitimate instruction boundaries and legitimate branch targets. As in the case of code integrity, checking can be performed in-line or out-of-line, orthogonal to the issue of how legitimate instruction boundaries are indicated.

Page code integrity techniques can be used to check only legitimate branch targets rather than all legitimate instruction boundaries.

Usage of out-of-line metadata to detect legitimate instruction boundaries and legitimate branch targets of different types can be done in support of code integrity, and also possibly other applications such as decoded instruction caches and binary translation.

### Unmarked Legacy Instructions

Unmarked legacy instructions plus unmarked new instructions can be used to support code integrity.

Hereinbefore are discussed legitimate instruction boundaries and legitimate branch targets of different types in support of code integrity for new instruction sets, designed from the outset to support objectives. However, code integrity is also sought for extending existing instruction sets since long-used, well-developed instruction set architectures are unlikely to be scrapped in deference to new entries.

Considering an example of an existing 32-bit RISC instruction set architecture, the instruction size may be set at 32-bits and strict instruction alignment imposed. An improved instruction set may be sought, for example to introduce support for both smaller (for example, 16-bit) and larger (such as 64-bit or 128-bit) instructions. The improved instruction set can be further extended to include the various types of code integrity techniques disclosed herein.

The improved instruction set may support a variable length instruction mode or may be modeless.

In the case of a new configuration that supports variable length instruction mode and if the existing-set 32-bit instructions cannot be distinguished from the instructions of different length without knowing the mode (decoding requires the mode to be known), out-of-line metadata can be used to indicate the mode to be associated with a group of instructions. Any suitable metadata technique can be used. A particularly useful metadata technique can have the outlying metadata in page tables. For example, a page table encoding can be included indicating that the page contains existing instruction set instructions rather than new instructions.

The new instruction sizes can be indicated in the page table or, since the page table bits are usually scarce, can be enabled using other techniques, as disclosed hereinbefore, possibly in addition to other properties such as legitimate instruction boundaries of the new instructions. Suitable techniques can include non-page table outlying metadata, or any of the instruction encoding techniques described hereinbefore.

In a modeless configuration, instructions of different lengths are to be distinguished simply by accessing common bits. Then, the strict instruction alignment techniques disclosed hereinbefore can be used to check for gradually larger possible overlying instruction boundaries to determine whether a larger overlaying instruction is present. The illustrative procedure has advantages and disadvantages (including possible fragmentation to pad small instructions to a next larger size).

The illustrative example enables a 32-bit RISC instruction set to be extended down to 16-bit instructions and up to 64-bit or 128=bit instructions with full support for preventing instruction misalignment. The technique works best with nesting instructions and strict instruction alignment, such as power of two sizes. Handling of odd-sized instructions, such as 24-bit and 40-bit instructions, is more difficult.

### Strawman Control Flow Integrity Instruction Set

Embodiments of systems and methods can use strawman techniques to enable code integrity and control flow integrity, in addition to instruction length and alignment.

Strawman techniques can be used to enforce legitimate instruction boundaries. Definition of a new instruction set can use any of the techniques for preventing instruction misalignment or overlapping instructions described hereinabove. These techniques indicate legitimate instruction boundaries on all or most instructions, and prevent branching into the middle of an instruction. Because the techniques affect so many instructions, overhead can be minimized by having only one or a few bits per instruction.

Examples of suitable techniques can include a bit per 16-bit ifetch chunk indicating location of legitimate instruction boundaries, templates in a larger ifetch chunk indicating legitimate instruction boundary location, strict instruction alignment, and others.

The strict instruction alignment technique is operable, for example, for an instruction set with nestable 16/32/64 bit instructions that can be distinguished by decoding. The strict instruction alignment technique is highly suitable for usage with legacy instruction sets.

A control register can be used to enable checking for legitimate instruction boundaries. Other suitable techniques can be used for enablement.

Strawman techniques can also be used for control flow target checking. Various changes of control flow include direct branches, indirect branches, direct or indirect calls, returns, exceptions, special case control flow changes, and the like. The changes in control flow may be subject to fairly narrow imposed restrictions.

Embodiments of the disclosed systems and methods use a highly suitable technique for control flow target checking, a CONTROL_FLOW_ASSERTION instruction.

The CONTROL_FLOW_ASSERTION instruction may have several versions, mainly to distinguish versions that have operands (such as the address that may have branched to the current instruction, or even an address range) from those that do not have such operands.

One example CONTROL_FLOW_ASSERTION instruction can have the form “CONTROL_FLOW_ASSERT bitmask,” including the instruction and a bitmask. The instruction has an Immediate constant bitmask that defines checks to be made. Several checks can be made in one instruction. Bits for the multiple checks are logically-ORed. If none of the conditions match, a trap or exception is thrown.

An example of a strawman set of bitmask bits can include: (a) a bit indicating that the instruction may or may not be reached by “falling through” from sequential execution from the previous instruction.

Some of the bitmask bits can use relative branches as a convenient form for defining “locality” so that: (b) the instruction may be the target of an unconditional direct branch (a relative code transfer), or (c) the instruction may be the target of a conditional direct branch (a relative code transfer).

Some of the bitmask bits can be used to support non-relative branches which tend to be “external” or non-local. Accordingly, a bitmask bit can indicate: (d) the instruction may be the target of a non-relative direct branch.

One or more of the bitmask bits can be used to support indirect branches which tend to be local and can be used in stylized manners. Accordingly, a bitmask bit can indicate: (e) the instruction may be the target of an indirect branch.

Bitmask bits can also be used in the case of function entry points so that: (f) the instruction may be the target of a relative function call, (g) the instruction may be the target of a non-relative or absolute function call, or (h) the instruction may be the target of an indirect function call.

In some embodiments, the bitmask bits can be used to distinguish branches used for tail recursion.

Bitmask bits can further be used in the case of return points so that: (i) the instruction may be the target of a function return instruction.

A CONTROL_FLOW_ASSERT bitmask that includes the functionality of all points (a) to (i) would have nine bits which may be reasonable, although reduction to eight bits may be desirable.

Another example CONTROL_FLOW_ASSERTION instruction can have the form “CONTROL_FLOW_ASSERT bitmask bitmaskNW,” including the instruction and two bitmasks. The instruction has a first Immediate constant bitmask that defines checks to be made, for example with the same functionality as disclosed hereinabove for the instruction with a single bitmask. The instruction also can have a second bitmask with almost exactly the same bits describing exactly the same checks, but with an additional test that the instruction branching here must be from a page marked non-writeable (NW).

A further example CONTROL_FLOW_ASSERTION instruction can have the form “CONTROL_FLOW_ASSERT bitmask bitmaskXO,” including the instruction and two bitmasks. In addition to the first immediate constant bitmask which defines the checks in the manner of the two instructions discussed hereinbefore, the instruction includes a second bitmask with almost exactly the same bits describing exactly the same checks, but includes an additional test that the instruction branching here must be from a page marked as execute only—not just non-writeable, but also not-readable. In this manner, control flow from pages that an intruder may be able to affect can be restricted.

Still another example CONTROL_FLOW_ASSERTION instruction can have the form “CONTROL_FLOW_ASSERT bitmask bitmaskF fromIP,” which includes the instruction and two bitmasks. In addition to the first immediate constant bitmask which defines the checks in the manner of the two instructions discussed hereinbefore, the instruction includes a second bitmask with almost exactly the same bits describing exactly the same checks, but includes an additional test that the “From Instruction Pointer” (fromIP) of the instruction branching to the CONTROL_FLOW_ASSERTION instruction location matches. The instruction enables restriction of certain types of control flow to only a single fromIP, but generically allow other fromIPs. The CONTROL_FLOW_ASSERTION instruction may be the target of the indirect branch at fromIP.

The usefulness of restricting CALL targets to only a single fromIP (or return) appears to be limited. In fact, indirect branch is the only instruction likely to admit such a single fromIP restriction. Therefore, the bitmaskF may not be necessary, but instead simply encoding may be suitable. Accordingly, a CONTROL_FLOW_ASSERTION instruction can have the form “CONTROL_FLOW_ASSERT_INDIRECT_TARGET fromIP,” in which the instruction may be the target of the indirect branch at fromIP. If the instruction is not the target, a trap can be generated.

Another example CONTROL_FLOW_ASSERTION instruction can have the form “CONTROL_FLOW_ASSERT bitmask bitmaskL,” which includes the instruction and two bitmasks. In addition to the first immediate constant bitmask which defines the checks in the manner of the two instructions discussed hereinbefore, the instruction includes a second bitmask with almost exactly the same bits describing exactly the same checks, but includes an additional test that the instruction branching to the target CONTROL_FLOW_ASSERTION instruction must be “local”.

The definition of local is problematic. Some example instructions are proposed that address possibly useful definitions of “locality”. For example, a CONTROL_FLOW_ASSERTION instruction of the form “CONTROL_FLOW_ASSERT bitmask bitmaskL Zbit,” in addition to the disclosed bitmask defining checks, the instruction has a second bitmask with almost exactly the same bits describing exactly the same checks, but includes an additional test that the instruction branching be “local” with locality defined to be that only the least significant bits of the from and to (current) address may differ. Zbit is the number of the most significant bit that may differ, and can be, for example, a 6-bit constant in the instruction for a 64-bit machine. Thus, for example, locality can be defined in the manner of “only allow jumps from within the same 16K region.”

Another example of a CONTROL_FLOW_ASSERTION instruction which allows only local branching can have the form “CONTROL_FLOW_ASSERT bitmask bitmaskL lo, hi.” In addition to the disclosed bitmask defining checks, the instruction has a second bitmask with almost exactly the same bits describing exactly the same checks, but includes an additional test that the instruction branching be “local” with locality defined to be in the interval (lo, hi). Accordingly, the fromIP must be within the specified range. The “lo, hi” designation may be absolute, or may be relative addresses. The interval may be relatively difficult to encode as compared to other techniques for defining locality.

A further example of a CONTROL_FLOW_ASSERTION instruction which allows only local branching can have the form “CONTROL_FLOW_ASSERT bitmask bitmaskL rel.” In addition to the disclosed bitmask defining checks, the instruction has a second bitmask with almost exactly the same bits describing exactly the same checks, but includes an additional test that the instruction branching be “local” with locality defined to be in the interval (ip−rel, ip+rel). Accordingly, the fromIP must be within the specified range. The “rel” designation is similar to the “lo, hi” designation, except the encoding is simplified to only one limit. The encoding may be a value or may be the log 2 of the limit.

An additional example of a CONTROL_FLOW_ASSERTION instruction which allows only local branching can have the form “CONTROL_FLOW_ASSERT bitmask bitmaskL lo0, hi0, lo1, hi1.” In addition to the disclosed bitmask defining checks, the instruction has a second bitmask with almost exactly the same bits describing exactly the same checks, but includes an additional test that the instruction branching be “local” with locality defined to be the union of the possible disjoint intervals [lo0, hi0] and [lo1,hi1]. Accordingly, the fromIP must be within the specified range. This form allows functions to be optimized into cold and hot regions, at the cost of encoding challenges.

The instruction definitions disclosed hereinabove have several varieties, typically described as instructions with a base bitmask, an additional bitmask, and tests. Any combination can be supported, generally subject to encoding limitations. For example, if deemed to be sufficiently important, all varieties could be supported on a variable length instruction set, or an instruction set with very long fixed length instructions. On a small instruction set, the varieties may be abbreviated, as found appropriate.

A combination instruction can have the form:
CONTROL_FLOW_ASSERT [bitmask] [bitmaskNW] [bitmaskXO] [bitmaskF frorniP] [bitmaskL . . . ].

A control register can be used for holding enable bits for each of the checks.

A generic CONTROL_FLOW_ASSERT instruction can be defined.

The control flow integrity checks are operations that look at the instruction that branched to the current instruction. The information is of the type that is contained, for example, in the Intel x86 processor's Last Branch Records, which were added to the Intel P6 (sixth generation x86 microprocessor microarchitecture) RTL.

The CONTROL_FLOW_ASSERT instructions are shorthand for operations involving the “last Branch Information”.

More general operations, such as “Instruction A can be reached from B and C but not D’ are too idiosyncratic to put in hardware, but can be expressed by general purpose code, if the last branch records are easily accessible.

Unfortunately, the last branch records are not easily accessible in current machines, but rather require a system call to access, since the records are located in privileged machine state registers (MSRs). Therefore, an additional enhancement is proposed, to make the last branch records more easily accessible to ordinary user code intended to perform control flow integrity checks beyond those directly supported.

One example enhancement is to place the LBRs (library file formats) in registers that can be read by user instructions, such as UNPRIVILEGED_READF_STATUS_REGISTER.

Another example enhancement is to create an instruction MOVE_LBR_TO_GPR, an approach similar to the instructions RDTSC (return time stamp counter) and RDPMC (read performance-monitoring counter) which also create special purpose instructions to read otherwise privileged registers from use code.

Referring to FIGS. 1A and 1B, schematic block diagrams depict an embodiment of a processor 100 that is operable to enforce control flow integrity. The illustrative processor 100 comprises logic 102 operable to execute a control flow integrity instruction 104 specified to verify changes in control flow and respond to verification failure by at least one of a trap or an exception.

In some embodiments, the processor 100 can include the logic 102 operable to execute a control flow integrity instruction 104 which is operable to execute the control flow integrity instruction 104 specified to verify changes in control flow comprising one or more conditions of at least one of instruction length or instruction alignment. Similarly, the control flow integrity instruction 104 can be specified to verify changes in control flow comprising changes resulting from direct branches, indirect branches, direct calls, indirect calls, returns, and exceptions.

In various embodiments, the processor 100 can include the logic 102 operable to execute a control flow integrity instruction 104 which is operable to execute the control flow integrity instruction 104 comprising an immediate constant bitmask 106 that defines at least one check to be made of at least one condition, the at least one check being logically-ORed and at least one of a trap or an exception is generated if none of the at least one condition matches.

The immediate constant bitmask 106 can comprise bitmask bits 108 that are operable to identify conditions. Example conditions can include whether the control flow integrity instruction 104 is reachable through sequential execution from a previous instruction. Other conditions can relate to branch conditions such as whether the control flow integrity instruction 104 is a target of an unconditional direct branch, whether the control flow integrity instruction 104 is a target of a conditional direct branch, whether the control flow integrity instruction 104 is a target of a non-relative direct branch, whether the control flow integrity instruction 104 is a target of an indirect branch, and the like. Other conditions can relate to function calls and returns including whether the control flow integrity instruction 104 is a target of a relative function call, whether the control flow integrity instruction 104 is a target of a non-relative or absolute function call, whether the control flow integrity instruction 104 is a target of an indirect function call, and whether the control flow integrity instruction 104 is a target of a function return instruction.

In some embodiments and/or applications, the processor 100 can include the logic 102 operable to execute a control flow integrity instruction 104 which is operable to execute the control flow integrity instruction 104 comprising a first bitmask 110 and a second bitmask 112. The first bitmask 110 can comprise an immediate constant bitmask that defines at least one check to be made of at least one condition, the at least one check being logically-ORed and at least one of a trap or an exception is generated if none of the at least one condition matches. The second bitmask 112 can define the at least one condition with an additional test that instruction branching is from a page marked non-writeable. In other embodiments and/or applications, the second bitmask 112 can define the at least one condition with an additional test that instruction branching is from a page marked execute only. In further other embodiments and/or applications, the second bitmask 112 can define the at least one condition with an additional test that from Instruction Pointer (fromIP) of instruction branching matches. In further other embodiments and/or applications, the second bitmask 112 can define the at least one condition with an additional test that instruction branching is local.

In some embodiments and/or applications, the processor 100 can include the logic 102 operable to execute a control flow integrity instruction 104 which is operable to execute the control flow integrity instruction 104 comprising a first bitmask 110, a second bitmask 112, and a designation of locality 114. The first bitmask 110 can comprise an immediate constant bitmask that defines at least one check to be made of at least one condition, the at least one check being logically-ORed and at least one of a trap or an exception is generated if none of the at least one condition matches. The second bitmask 112 can define the at least one condition with an additional test that instruction branching is local and the designation of locality 114 defines locality.

In further embodiments and/or applications, the processor 100 can include the logic 102 operable to execute a control flow integrity instruction 104 which is operable to execute the control flow integrity instruction 104 comprising a first bitmask 110, a second bitmask 112, and a and a designation of range 116. The first bitmask 110 can comprise an immediate constant bitmask that defines at least one check to be made of at least one condition, the at least one check being logically-ORed and at least one of a trap or an exception is generated if none of the at least one condition matches. The second bitmask 112 can define the at least one condition with an additional test that instruction branching is local and the designation of range 116 defines locality in terms of a range of addresses.

In still other embodiments and/or applications, the processor 100 can include the logic 102 operable to execute a control flow integrity instruction 104 which is operable to execute the control flow integrity instruction 104 comprising a first bitmask 110, a second bitmask 112, and a and a designation of interval 118. The first bitmask 110 can comprise an immediate constant bitmask that defines at least one check to be made of at least one condition, the at least one check being logically-ORed and at least one of a trap or an exception is generated if none of the at least one condition matches. The second bitmask 112 can define the at least one condition with an additional test that instruction branching is local and the designation of interval 118 defines locality as range within which from Instruction Pointer (fromIP) is included.

In still additional embodiments, the processor 100 can include the logic 102 operable to execute a control flow integrity instruction 104 which is operable to execute a control flow assert indirect target from Instruction Pointer (fromIP) instruction 120 wherein the control flow assert indirect target from Instruction Pointer (fromIP) instruction is a target of an indirect branch from IP, otherwise a trap is generated.

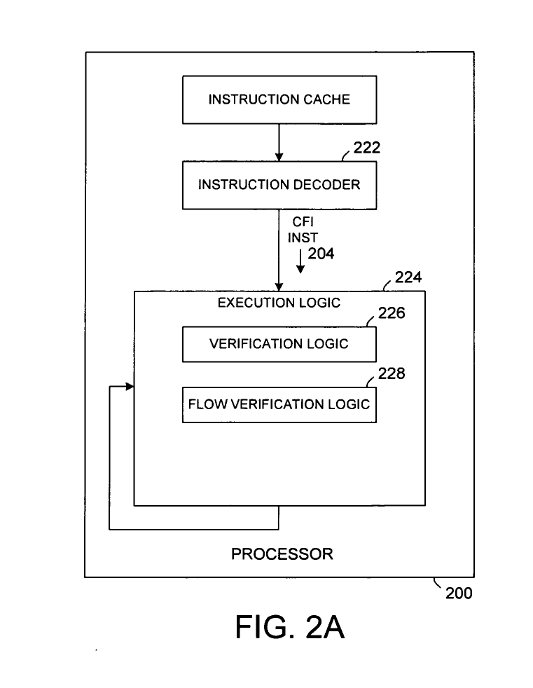

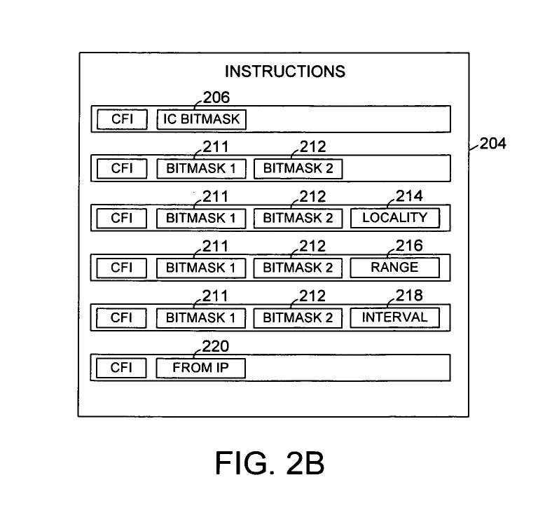

Referring to FIGS. 2A and 2B, schematic block diagrams illustrate another embodiment of a processor 200 operable for implementing control flow integrity. The depicted processor 200 can comprise an instruction decoder 222 operable to decode a control flow integrity instruction 204 and execution logic 224 coupled to the instruction decoder 222 which is operable to verify changes in control flow and respond to verification failure by at least one of a trap or an exception.

In a particular example embodiment of the processor 200, the execution logic 224 can further comprise logic 226 operable to verify changes in control flow comprising conditions of at least one of an instruction length or an instruction alignment.

In another particular example embodiment of the processor 200, the execution logic 224 can further comprise logic 228 operable to verify changes in control flow comprising changes resulting from direct branches, indirect branches, direct calls, indirect calls, returns, and exceptions.

In an embodiment of the processor 200, the instruction decoder 222 can be operable to decode the control flow integrity instruction 204 which specifies an immediate constant bitmask 206 and the execution logic 224 can further comprise logic that is operable to define at least one check to be made of at least one condition based on the immediate constant bitmask and logically-OR the bitmask, thus generating at least one of a trap or an exception if none of the at least one condition matches. In various embodiments, applications, conditions, and/or circumstances, the immediate constant bitmask 206 comprises bitmask bits operable to identify various conditions. For example the bitmask bits can be used to identify whether the control flow integrity instruction 204 is reachable through sequential execution from a previous instruction. The bitmask bits can be used to identify branch conditions including whether the control flow integrity instruction 204 is a target of an unconditional direct branch, whether the control flow integrity instruction 204 is a target of a conditional direct branch, whether the control flow integrity instruction 204 is a target of a non-relative direct branch, whether the control flow integrity instruction 204 is a target of an indirect branch, and other branches. The bitmask bits can also be used to identify function calls and returns including whether the control flow integrity instruction 204 is a target of a relative function call, whether the control flow integrity instruction 204 is a target of a non-relative or absolute function call, whether the control flow integrity instruction 204 is a target of an indirect function call, whether the control flow integrity instruction 204 is a target of a function return instruction, and similar calls.

In some embodiments of the processor 200, the instruction decoder 222 can be operable to decode an control flow integrity instruction 204 which specifies a first immediate constant bitmask 211 and a second bitmask 212. The execution logic 224 can further comprise logic that is operable to define at least one check to be made of at least one condition based on the first immediate constant bitmask 211 and logically-ORing the first immediate constant bitmask 211 and generating at least one of a trap or an exception if none of the at least one condition matches. The execution logic 224 can be further operable to define, based on the second bitmask 212, the at least one condition with an additional test that instruction branching is selected from one or more members of a group consisting of a page marked non-writeable, a page marked execute only, Instruction Pointer (fromIP), local, local with designation of locality defining locality, local with designation of range defining locality, and local with range of locality specified by Instruction Pointer (fromIP).

In some processor embodiments 200, the execution logic 224 can further comprise logic operable to execute a control flow assert indirect target from Instruction Pointer (fromIP) instruction 220 wherein the control flow assert indirect target from Instruction Pointer (fromIP) instruction 220 is target of an indirect branch from IP, otherwise a trap is generated.

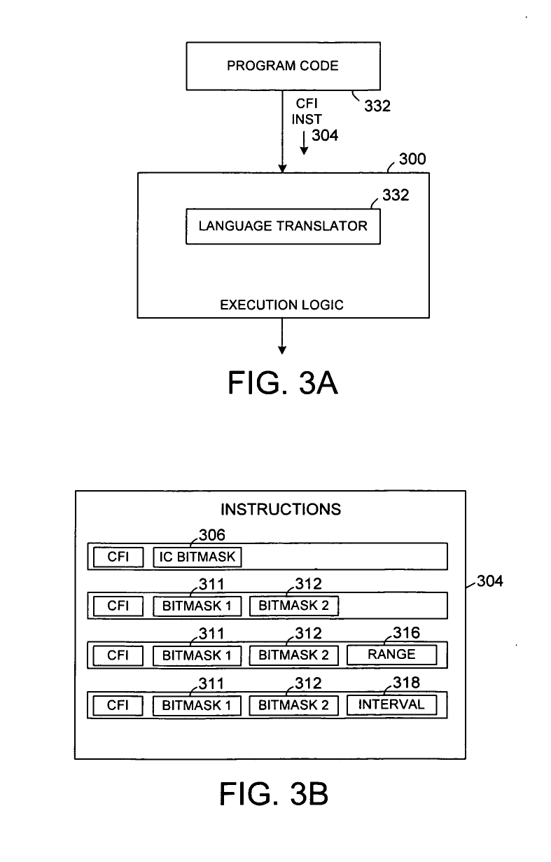

Referring to FIGS. 3A and 3B, schematic block diagrams illustrate an embodiment of an executable logic 300 that can be used to ensure control flow integrity. The illustrative execution logic 300 can comprise a computer language translator 330 operable to translate a program code 332 comprising a plurality of instructions including at least one control flow integrity instruction 304 specified to verify changes in control flow and respond to verification failure by at least one of a trap or an exception.

In various embodiments, the computer language translator 330 can be any suitable translator such as a compiler operable to compile the program code 332, an interpreter operable to interpret the program code 332, or any other functional element operable to translate the program code 332.

In at least some embodiments, control flow integrity instructions can have various aspects of functionality. For example, the at least control flow integrity instruction 304 can be specified to verify changes in control flow comprising conditions of at least one of an instruction length or an instruction alignment. In various embodiments, implementations, applications, and conditions, the at least one control flow integrity instruction 304 can be specified to verify changes in control flow comprising changes resulting from direct branches, indirect branches, direct calls, indirect calls, returns, exceptions, and the like.

In various embodiments, the illustrative execution logic 300 can handle one or more control flow integrity instructions 304 specified to comprise an immediate constant bitmask 306 that defines at least one check to be made of at least one condition. The one or more control flow integrity instructions 304 can be further specified to logically-OR the at least one check and generate at least one of a trap or an exception if none of the at least one condition matches.

In various embodiments, applications, conditions, and/or circumstances, the illustrative execution logic 300 can handle one or more control flow integrity instructions 304 specified to comprise an immediate constant bitmask 306 comprises bitmask bits operable to identify various conditions. In a particular example, the bitmask bits can be used to identify whether the control flow integrity instruction 304 is reachable through sequential execution from a previous instruction. The bitmask bits can be used to identify branch conditions including whether the control flow integrity instruction 304 is a target of an unconditional direct branch, whether the control flow integrity instruction 304 is a target of a conditional direct branch, whether the control flow integrity instruction 304 is a target of a non-relative direct branch, whether the control flow integrity instruction 304 is a target of an indirect branch, and other branches. The bitmask bits can also be used to identify function calls and returns including whether the control flow integrity instruction 304 is a target of a relative function call, whether the control flow integrity instruction 304 is a target of a non-relative or absolute function call, whether the control flow integrity instruction 304 is a target of an indirect function call, whether the control flow integrity instruction 304 is a target of a function return instruction, and similar calls.

In various embodiments, the illustrative execution logic 300 can handle one or more control flow integrity instructions 304 specified to comprise an immediate constant bitmask 306 that defines at least one check to be made of at least one condition. The at least one control flow integrity instruction 304 can be specified to logically-OR the at least one check and generate at least one of a trap or an exception if none of the at least one condition matches. The at least one control flow integrity instruction 304 can be further specified to define the at least one condition with an additional test that instruction branching is from a page marked non-writeable.

In various embodiments, the execution logic 300 can be operable to execute the at least one control flow integrity instruction 304 specified to comprise a first immediate constant bitmask 311 that defines at least one check to be made of at least one condition and a second bitmask 312. In one example functionality, the at least one control flow integrity instruction 304 can be specified to logically-OR the at least one check and generate at least one of a trap or an exception if none of the at least one condition matches. The at least one control flow integrity instruction 304 can be further specified to define the at least one condition with an additional test that instruction branching is from specification by Instruction Pointer (fromIP).

In another example functionality, the at least one control flow integrity instruction 304 can be specified to logically-OR the at least one check and generate at least one of a trap or an exception if none of the at least one condition matches. The at least one control flow integrity instruction 304 can be further specified to define the at least one condition with an additional test that instruction branching is local.

In still another example functionality, the at least one control flow integrity instruction 304 can be specified to logically-OR the at least one check and generate at least one of a trap or an exception if none of the at least one condition matches. The at least one control flow integrity instruction 304 can be further specified to define the at least one condition with an additional test that instruction branching is local and the designation of locality defines locality.

In further various embodiments, the execution logic 300 can be operable to execute the at least one control flow integrity instruction 304 specified to comprise a first immediate constant bitmask 311 that defines at least one check to be made of at least one condition, a second bitmask 312, and a designation of range 316. The at least one control flow integrity instruction 304 can be specified to logically-OR the at least one check and generate at least one of a trap or an exception if none of the at least one condition matches. The at least one control flow integrity instruction 304 can be further specified to define the at least one condition with an additional test that instruction branching is local and the designation of range 316 defines locality.

In still further various embodiments, the execution logic 300 can be operable to execute the at least one control flow integrity instruction 304 specified to comprise a first immediate constant bitmask 311 that defines at least one check to be made of at least one condition, a second bitmask 312, and a designation of interval 318. The at least one control flow integrity instruction 304 is specified to logically-OR the at least one check and generate at least one of a trap or an exception if none of the at least one condition matches. The at least one control flow integrity instruction 304 can be further specified to define the at least one condition with an additional test that instruction branching is local and the designation of interval 318 defines locality as range within which from Instruction Pointer (fromIP) is included.

In still additional embodiments, the execution logic 300 can be operable to execute the at least one control flow integrity instruction 304 is an indirect target from Instruction Pointer (fromIP) instruction wherein the instruction is a target of an indirect branch from IP, otherwise a trap is generated.

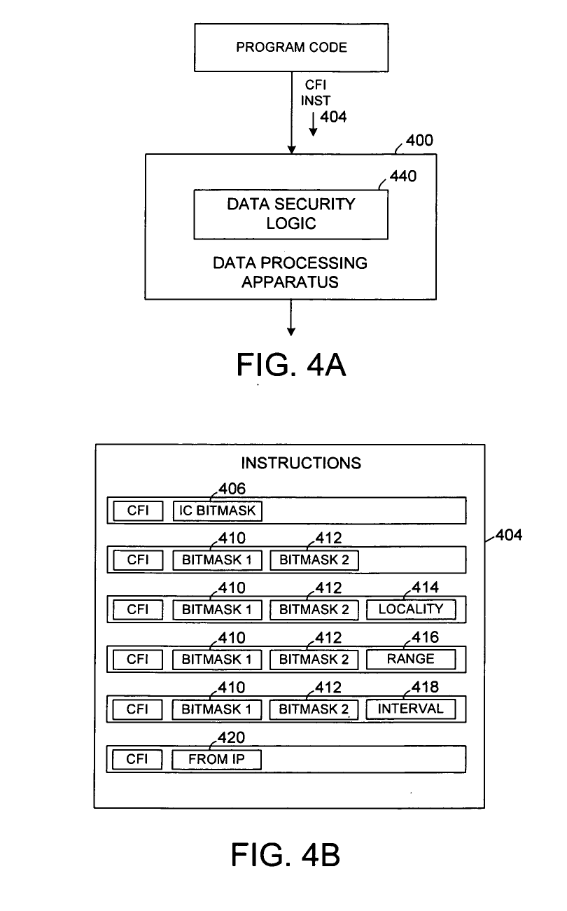

Referring to FIGS. 4A and 4B, a schematic block diagram shows an embodiment of a data processing apparatus 400 for usage in controlling flow integrity. The data processing apparatus 400 comprises a data security logic 440 operable to use a control flow integrity instruction 404 specified to verify changes in control flow and respond to verification failure by at least one of a trap or an exception.

Various embodiments of the data processing apparatus 400 can be operable is one or more of multiple different applications and configurations. For example, the data security logic 440 can further comprise logic operable to use the control flow integrity instruction 404 in a video gaming server application. Similarly, the data security logic 440 can comprise logic operable to use the control flow integrity instruction 404 in a video gaming client application.

In other example applications, the data security logic 440 can comprise logic operable to use the control flow integrity instruction 404 in a copyrighted content anti-piracy application.

The data security logic 440 can comprise logic operable to use the control flow integrity instruction 404 in an information technology server application. Similarly, the data security logic 440 can comprise logic operable to use the control flow integrity instruction 404 in an information technology client application.

The data security logic 440 is operable to execute the control flow integrity instruction 404 specified to verify changes in control flow including conditions of at least one of an instruction length or an instruction alignment.

In various embodiments, implementations, applications, and conditions, the control flow integrity instruction 404 can be specified to verify changes in control flow comprising changes resulting from direct branches, indirect branches, direct calls, indirect calls, returns, exceptions, and the like.

In an example configuration of the data processing apparatus 400, the data security logic 440 can be operable to execute the control flow integrity instruction 404 that uses an immediate constant bitmask 406 that defines at least one check to be made of at least one condition, the at least one check being logically-ORed and at least one of a trap or an exception is generated if none of the at least one condition matches.

The immediate constant bitmask 406 comprises bitmask bits operable to identify various particular conditions. Example conditions can include whether the control flow integrity instruction 404 is reachable through sequential execution from a previous instruction. Some conditions can relate to branching such as whether the control flow integrity instruction 404 is a target of an unconditional direct branch, whether the control flow integrity instruction 404 is a target of a conditional direct branch, whether the control flow integrity instruction 404 is a target of a non-relative direct branch, whether the control flow integrity instruction 404 is a target of an indirect branch, or similar branching conditions. Some conditions can relate to branching including whether the control flow integrity instruction 404 is a target of a relative function call, whether the control flow integrity instruction 404 is a target of a non-relative or absolute function call, whether the control flow integrity instruction 404 is a target of an indirect function call, whether the control flow integrity instruction 404 is a target of a function return instruction, and other returns.

In another example, the control flow integrity instruction 404 can comprise a first bitmask 410, a second bitmask 412, and a designation of interval 418. The first bitmask 410 can comprise an immediate constant bitmask 406 that defines at least one check to be made of at least one condition, the at least one check being logically-ORed and at least one of a trap or an exception is generated if none of the at least one condition matches. The second bitmask 412 can comprise definition of the at least one condition with an additional test that instruction branching is selected from a group consisting of a page marked non-writeable, a page marked execute only, Instruction Pointer (fromIP) of instruction branching matches, local, local with the designation of locality 414 defining locality, local with the designation of range 416 defining locality, and local with the designation of interval 418 defining locality as range within which from Instruction Pointer (fromIP) 420 is included.

In a further example, the control flow integrity instruction 404 can comprise a control flow assert indirect target from Instruction Pointer (fromIP) instruction wherein the instruction is target of an indirect branch from IP, otherwise a trap is generated.

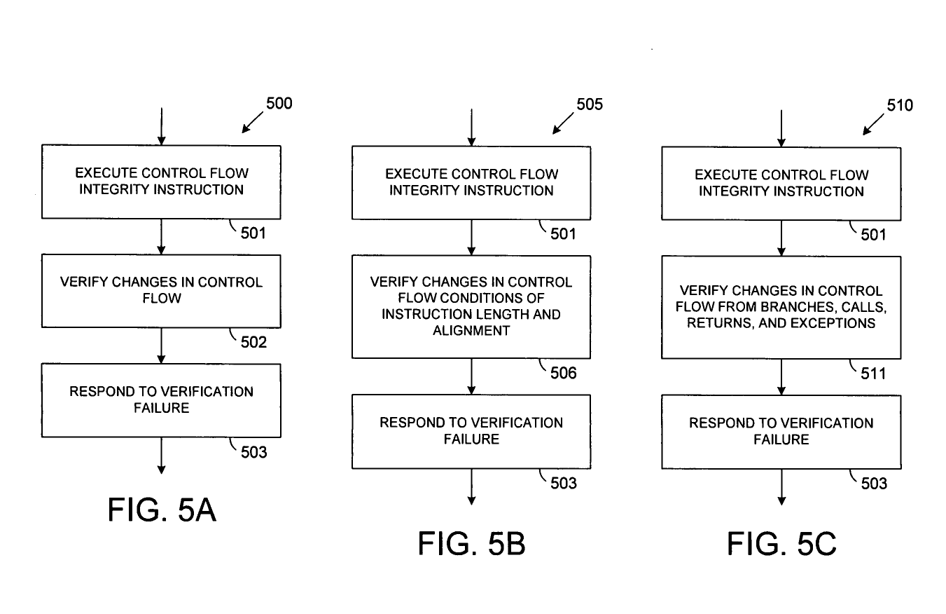

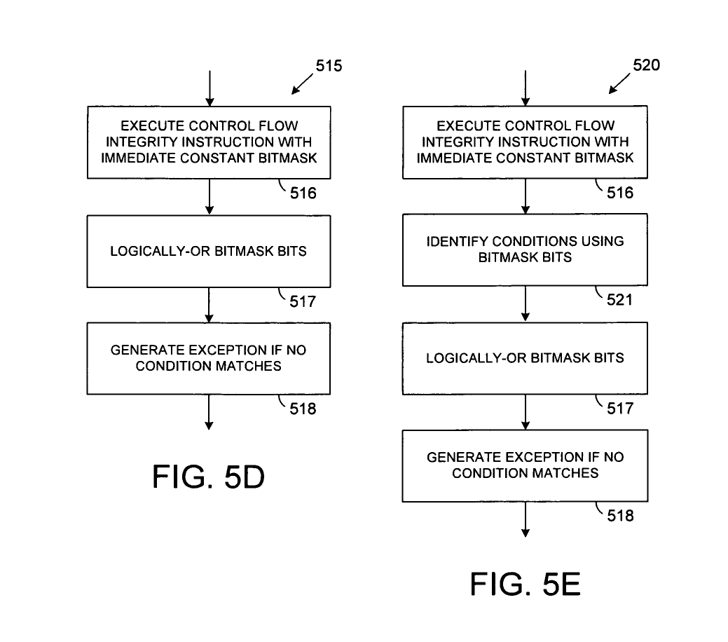

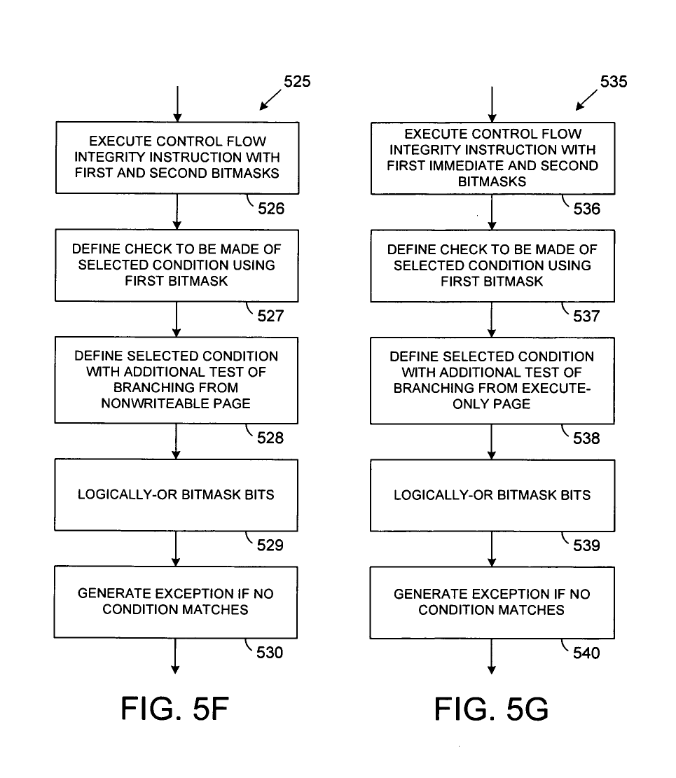

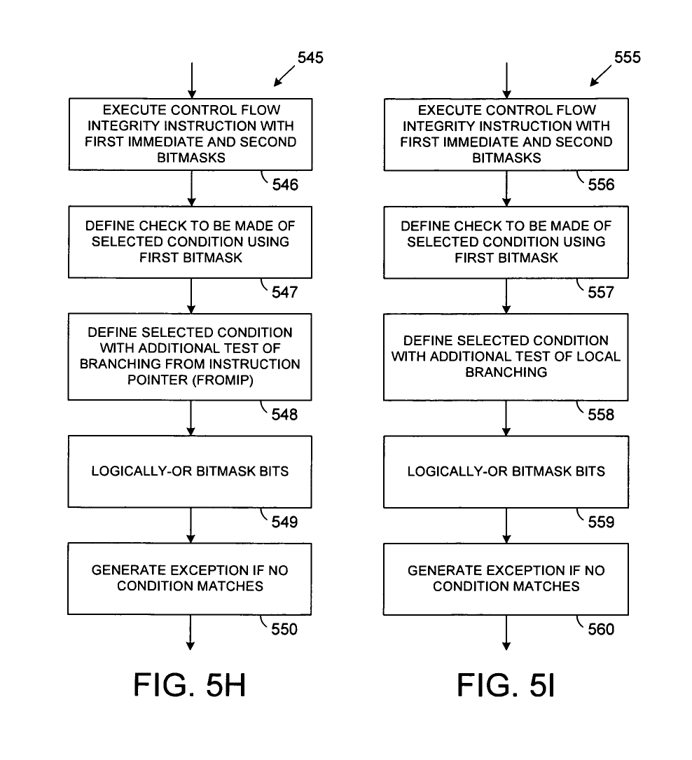

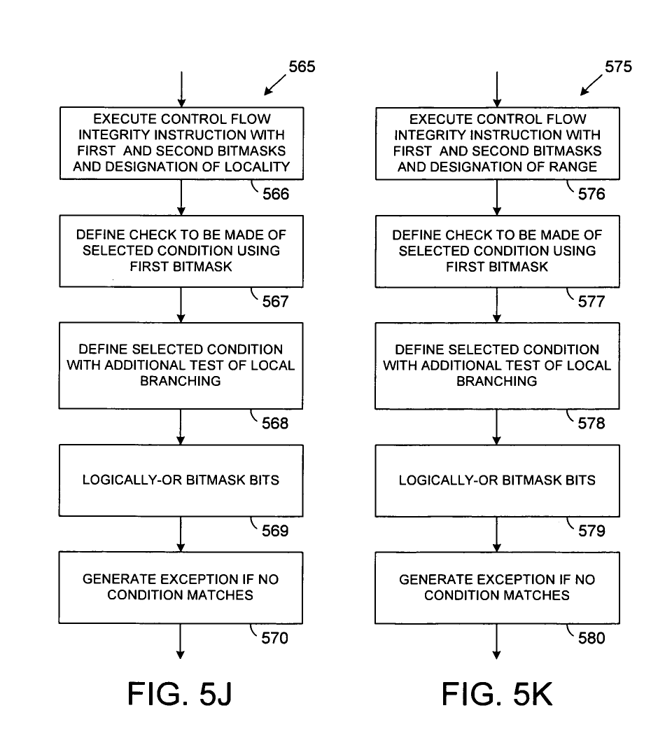

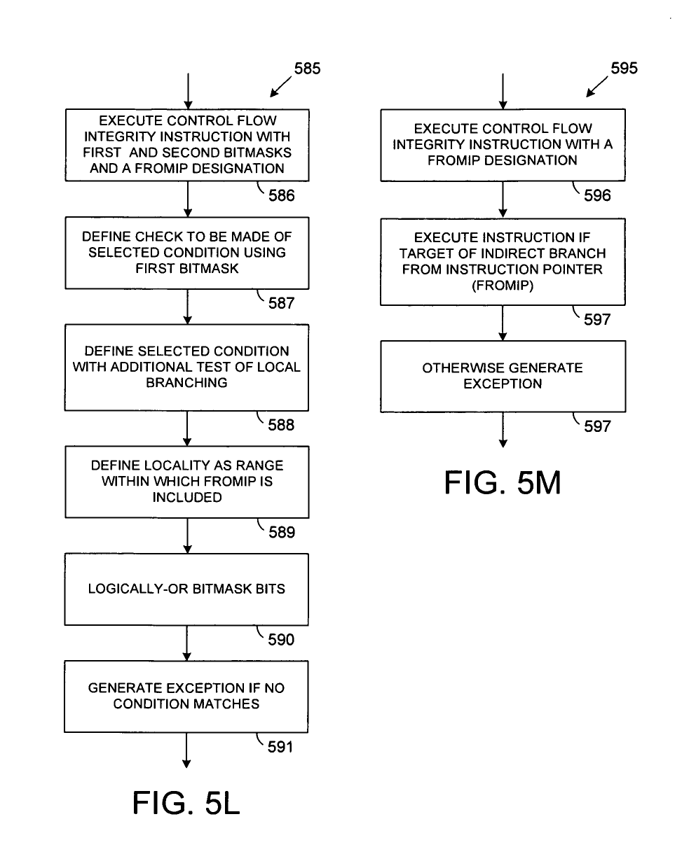

Referring to FIGS. 5A through 5M, schematic flow charts depict an embodiment or embodiments of a method 500 for controlling flow integrity in a data processing system. As shown in FIG. 5A, the illustrative method 500 for controlling flow integrity can comprise executing 501 a control flow integrity instruction specified to verify 502 changes in control flow, and responding 503 to verification failure by at least one of a trap or an exception. FIGS. 5B through 5M illustrate a embodiments of methods including configuration of a several actions and operation of those actions under particular conditions.

Referring to FIG. 5B, a method 505 for controlling flow integrity can further comprise executing 506 the control flow integrity instruction specified to verify changes in control flow comprising conditions of at least one of instruction length or instruction alignment.

Referring to FIG. 5C, a method 510 for controlling flow integrity can further comprise executing 511 the control flow integrity instruction specified to verify changes in control flow comprising changes resulting from direct branches, indirect branches, direct calls, indirect calls, returns, and exceptions.

Referring to FIG. 5D, a method 515 for controlling flow integrity can further comprise executing 516 the control flow integrity instruction comprising an immediate constant bitmask that defines at least one check to be made of at least one condition, the at least one check being logically-ORed 517 and at least one of a trap or an exception is generated 518 if none of the at least one condition matches.

Referring to FIG. 5E, a method 520 for controlling flow integrity can further comprise identifying 521 via bitmask bits in the immediate constant bitmask conditions. The bitmask bits in the immediate constant bitmask can be selected from various conditions and circumstances including whether the control flow integrity instruction is reachable through sequential execution from a previous instruction. The bitmask bits in the immediate constant bitmask can further be selected from various conditions and circumstances relating to branching including whether the control flow integrity instruction is a target of an unconditional direct branch, whether the control flow integrity instruction is a target of a conditional direct branch, whether the control flow integrity instruction is a target of a non-relative direct branch, whether the control flow integrity instruction is a target of an indirect branch, and the like. The bitmask bits in the immediate constant bitmask can also be selected from various conditions and circumstances relating to function calls and returns such as whether the control flow integrity instruction is a target of a relative function call, whether the control flow integrity instruction is a target of a non-relative or absolute function call, whether the control flow integrity instruction is a target of an indirect function call, whether the control flow integrity instruction is a target of a function return instruction, and similar calls and returns.

Referring to FIG. 5F, a method 525 for controlling flow integrity can further comprise executing 526 the control flow integrity instruction comprising a first immediate constant bitmask and a second bitmask, defining 527 via the first immediate constant bitmask at least one check to be made of at least one condition, and defining 528 via the second bitmask the at least one condition with an additional test that instruction branching is from a page marked non-writeable. The method 525 can further comprise logically-ORing 529 the at least one check, and generating 530 at least one of a trap or an exception is generated if none of the at least one condition matches.

Referring to FIG. 5G, a method 535 for controlling flow integrity can further comprise executing 536 the control flow integrity instruction comprising a first immediate constant bitmask and a second bitmask, defining 537 via the first immediate constant bitmask at least one check to be made of at least one condition, and defining 538 via the second bitmask the at least one condition with an additional test that instruction branching is from a page marked execute only. The method 535 can further comprise logically-ORing 539 the at least one check, and generating 540 at least one of a trap or an exception is generated if none of the at least one condition matches.

Referring to FIG. 5H, a method 545 for controlling flow integrity can further comprise executing 546 the control flow integrity instruction comprising a first immediate constant bitmask and a second bitmask, defining 547 via the first immediate constant bitmask at least one check to be made of at least one condition, and defining 548 via the second bitmask the at least one condition with an additional test that from Instruction Pointer (fromIP) of instruction branching matches. The method 545 can further comprise logically-ORing 549 the at least one check, and generating 550 at least one of a trap or an exception is generated if none of the at least one condition matches.

Referring to FIG. 5I, a method 555 for controlling flow integrity can further comprise executing 556 the control flow integrity instruction comprising a first immediate constant bitmask and a second bitmask, defining 557 via the first immediate constant bitmask at least one check to be made of at least one condition, and defining 558 via the second bitmask the at least one condition with an additional test that instruction branching is local. The method 555 can further comprise logically-ORing 559 the at least one check, and generating 560 at least one of a trap or an exception is generated if none of the at least one condition matches.

Referring to FIG. 5J, a method 565 for controlling flow integrity can further comprise executing 566 the control flow integrity instruction comprising a first immediate constant bitmask, a second bitmask, and a designation of locality, defining 567 via the first immediate constant bitmask at least one check to be made of at least one condition, and defining 568 via the second bitmask the at least one condition with an additional test that instruction branching is local. The method 565 can further comprise defining 569 locality via the designation of locality, logically-ORing 570 the at least one check, and generating 571 at least one of a trap or an exception is generated if none of the at least one condition matches.

Referring to FIG. 5K, a method 575 for controlling flow integrity can further comprise executing 576 the control flow integrity instruction comprising a first immediate constant bitmask, a second bitmask, and a designation of range, defining 577 via the first immediate constant bitmask at least one check to be made of at least one condition, and defining 578 via the second bitmask the at least one condition with an additional test that instruction branching is local. The method 575 can further comprise defining 579 locality in terms of a range of addresses via the designation of range, logically-ORing 580 the at least one check, and generating 581 at least one of a trap or an exception is generated if none of the at least one condition matches.

Referring to FIG. 5L, a method 585 for controlling flow integrity can further comprise executing 586 the control flow integrity instruction comprising a first immediate constant bitmask, a second bitmask, and a from Instruction Pointer (fromIP) designation, defining 587 via the first immediate constant bitmask at least one check to be made of at least one condition, and defining 588 via the second bitmask the at least one condition with an additional test that instruction branching is local. The method 585 can further comprise defining 589 via the designation of interval locality as range within which from Instruction Pointer (fromIP) is included, logically-ORing 590 the at least one check, and generating 591 at least one of a trap or an exception is generated if none of the at least one condition matches.

Referring to FIG. 5M, a method 595 for controlling flow integrity can further comprise executing 596 a control flow assert indirect target from Instruction Pointer (fromIP) instruction wherein the control flow assert indirect target from Instruction Pointer (fromIP) instruction is a target 597 of an indirect branch from IP, otherwise a trap is generated 598.

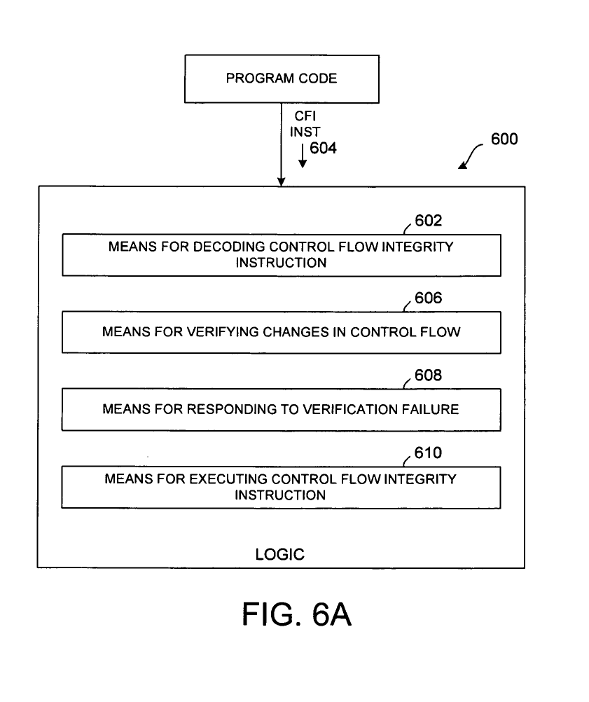

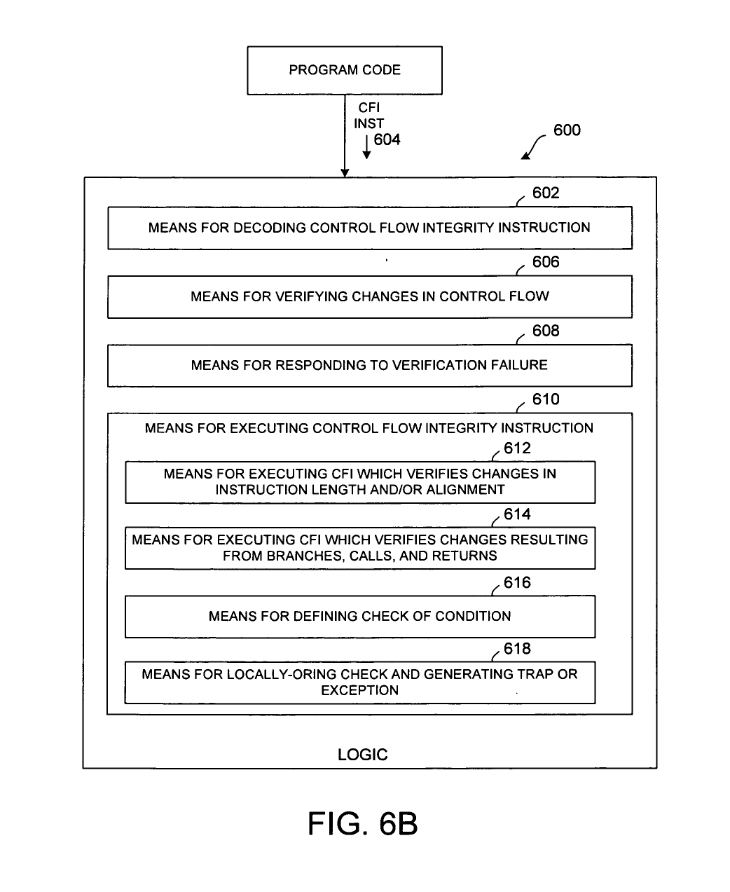

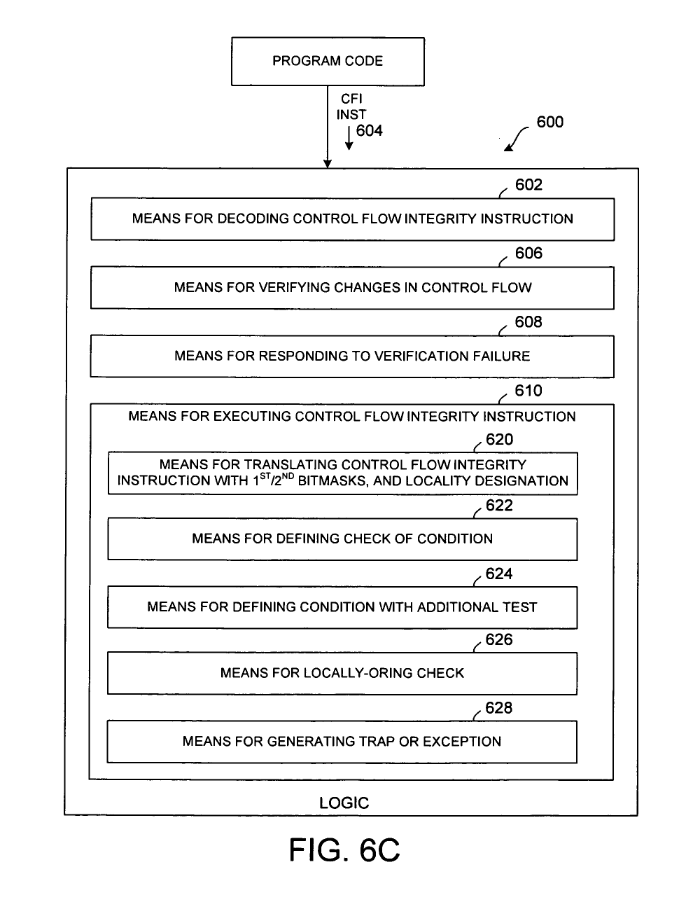

Referring to FIGS. 6A, 6B, and 6C, a schematic block diagram depicts an embodiment of a data processing apparatus 600 for usage in controlling flow integrity. The data processing apparatus 600 can comprise means 602 for decoding a control flow integrity instruction 604, means 606 for verifying changes in control flow, and means 608 for responding to verification failure by at least one of a trap or an exception.

In some embodiments, the data processing apparatus 600 can further comprise means 610 for executing the control flow integrity instruction.

The data processing apparatus 600 can be configured for usage in various applications, for example can include means for executing the control flow integrity instruction 604 in a video gaming server application, a video gaming client application, a copyrighted content anti-piracy application, an information technology server application, an information technology client application, data processing servers and clients, communications devices, and any other suitable application.

In some embodiments, the data processing apparatus 600 can comprise means 612 for executing the control flow integrity instruction 604 which is specified to verify changes in control flow comprising conditions of at least one of an instruction length or an instruction alignment. The data processing apparatus 600 can comprise means 614 for verifying changes in control flow using the control flow integrity instruction 604 wherein the verified changes in control flow comprise changes resulting from direct branches, indirect branches, direct calls, indirect calls, returns, and exceptions.

The data processing apparatus 600 can be operable to execute the control flow integrity instruction 604 using functional elements comprising means 616 for defining at least one check to be made of at least one condition using an immediate constant bitmask of the control flow integrity instruction, means 618 for logically-ORing the at least one check, and means for generating at least one of a trap or an exception if none of the at least one condition matches.

In various embodiments, the data processing apparatus 600 can execute the control flow integrity instruction that uses the immediate constant bitmask comprising bitmask bits operable to identify one or more of various conditions. Conditions can include whether the control flow integrity instruction is reachable through sequential execution from a previous instruction. Other conditions can relate to branching including whether the control flow integrity instruction is a target of an unconditional direct branch, whether the control flow integrity instruction is a target of a conditional direct branch, whether the control flow integrity instruction is a target of a non-relative direct branch, whether the control flow integrity instruction is a target of an indirect branch, and the like. Further conditions can relate to calls and returns such as whether the control flow integrity instruction is a target of a relative function call, whether the control flow integrity instruction is a target of a non-relative or absolute function call, whether the control flow integrity instruction is a target of an indirect function call, whether the control flow integrity instruction is a target of a function return instruction, and others.

The data processing apparatus 600 can further be operable to execute the control flow integrity instruction 604 using functional elements comprising means 620 for translating the control flow integrity instruction comprising a first immediate constant bitmask, a second bitmask, and a designation of interval, means 622 via the first immediate constant bitmask for defining at least one check to be made of at least one condition using the, and means 624 via the second bitmask for defining the at least one condition with an additional test that instruction branching is selected from, for example, a page marked non-writeable, a page marked execute only, Instruction Pointer (fromIP) of instruction branching matches, local, local with the designation of locality defining locality, local with the designation of range defining locality, and local with the designation of interval defining locality as range within which from Instruction Pointer (fromIP). The functional elements can further include means 626 for logically-ORing the at least one check, and means 628 for generating at least one of a trap or an exception if none of the at least one condition matches.

Terms “substantially”, “essentially”, or “approximately”, that may be used herein, relate to an industry-accepted variability to the corresponding term. Such an industry-accepted variability ranges from less than one percent to twenty percent and corresponds to, but is not limited to, materials, shapes, sizes, functionality, values, process variations, and the like. The term “coupled”, as may be used herein, includes direct coupling and indirect coupling via another component or element where, for indirect coupling, the intervening component or element does not modify the operation. Inferred coupling, for example where one element is coupled to another element by inference, includes direct and indirect coupling between two elements in the same manner as “coupled”.

The illustrative pictorial diagrams depict structures and process actions in a manufacturing process. Although the particular examples illustrate specific structures and process acts, many alternative implementations are possible and commonly made by simple design choice. Manufacturing actions may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, shapes, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

1. A processor comprising:
logic operable to execute a control flow integrity instruction specified to verify changes in control flow and respond to verification failure by at least one of a trap or an exception.

2. The processor according to claim 1 wherein the logic operable to execute a control flow integrity instruction includes:
logic operable to execute a control flow integrity instruction specified to verify changes in control flow comprising one or more conditions of at least one of instruction length or instruction alignment.

3. The processor according to claim 1 wherein the logic operable to execute a control flow integrity instruction includes:
logic operable to execute a control flow integrity instruction specified to verify changes in control flow comprising changes resulting from direct branches, indirect branches, direct calls, indirect calls, returns, and exceptions.

4. The processor according to claim 1 wherein the logic operable to execute a control flow integrity instruction includes:
logic operable to execute a control flow integrity instruction comprising an immediate constant bitmask that defines at least one check to be made of at least one condition, the at least one check being logically-ORed and at least one of a trap or an exception is generated if none of the at least one condition matches.

5. The processor according to claim 4 wherein the immediate constant bitmask comprises:
one or more bitmask bits operable to identify one or more conditions selected from a group consisting of:
whether the control flow integrity instruction is reachable through sequential execution from a previous instruction;
whether the control flow integrity instruction is a target of an unconditional direct branch;
whether the control flow integrity instruction is a target of a conditional direct branch;
whether the control flow integrity instruction is a target of a non-relative direct branch;
whether the control flow integrity instruction is a target of an indirect branch;
whether the control flow integrity instruction is a target of a relative function call;
whether the control flow integrity instruction is a target of a non-relative or absolute function call;
whether the control flow integrity instruction is a target of an indirect function call; and
whether the control flow integrity instruction is a target of a function return instruction.

6. The processor according to claim 1 wherein the logic operable to execute a control flow integrity instruction includes:
logic operable to execute a control flow integrity instruction comprising a first bitmask and a second bitmask, wherein
the first bitmask comprises an immediate constant bitmask that defines at least one check to be made of at least one condition, the at least one check being logically-ORed and at least one of a trap or an exception is generated if none of the at least one condition matches; and
the second bitmask comprises a definition of the at least one condition with an additional test that instruction branching is from a page marked non-writeable.

7. The processor according to claim 1 wherein the logic operable to execute a control flow integrity instruction includes:
logic operable to execute a control flow integrity instruction comprising a first bitmask and a second bitmask, wherein
the first bitmask comprises an immediate constant bitmask that defines at least one check to be made of at least one condition, the at least one check being logically-ORed and at least one of a trap or an exception is generated if none of the at least one condition matches; and
the second bitmask comprises a definition of the at least one condition with an additional test that instruction branching is from a page marked execute only.

8. The processor according to claim 1 wherein the logic operable to execute a control flow integrity instruction includes:
logic operable to execute a control flow integrity instruction comprising a first bitmask and a second bitmask, wherein
the first bitmask comprises an immediate constant bitmask that defines at least one check to be made of at least one condition, the at least one check being logically-ORed and at least one of a trap or an exception is generated if none of the at least one condition matches; and
the second bitmask comprises definition of the at least one condition with an additional test that from Instruction Pointer (fromIP) of instruction branching matches.

9. The processor according to claim 1 wherein the logic operable to execute a control flow integrity instruction includes:
logic operable to execute a control flow integrity instruction comprising a first bitmask and a second bitmask, wherein
the first bitmask comprises an immediate constant bitmask that defines at least one check to be made of at least one condition, the at least one check being logically-ORed and at least one of a trap or an exception is generated if none of the at least one condition matches; and
the second bitmask comprises definition of the at least one condition with an additional test that instruction branching is local.

10. The processor according to claim 1 wherein the logic operable to execute a control flow integrity instruction includes:
logic operable to execute a control flow integrity instruction comprising a first bitmask, a second bitmask, and a designation of locality, wherein
the first bitmask comprises an immediate constant bitmask that defines at least one check to be made of at least one condition, the at least one check being logically-ORed and at least one of a trap or an exception is generated if none of the at least one condition matches; and
the second bitmask comprises definition of the at least one condition with an additional test that instruction branching is local and the designation of locality defines locality.

11. The processor according to claim 1 wherein the logic operable to execute a control flow integrity instruction includes:
logic operable to execute a control flow integrity instruction comprising a first bitmask, a second bitmask, and a designation of range, wherein
the first bitmask comprising an immediate constant bitmask that defines at least one check to be made of at least one condition, the at least one check being logically-ORed and at least one of a trap or an exception is generated if none of the at least one condition matches; and
the second bitmask comprising definition of the at least one condition with an additional test that instruction branching is local and the designation of range defines locality in terms of a range of addresses.

12. The processor according to claim 1 wherein the logic operable to execute a control flow integrity instruction includes:
logic operable to execute a control flow integrity instruction comprising a first bitmask, a second bitmask, and a designation of interval, wherein
the first bitmask comprises an immediate constant bitmask that defines at least one check to be made of at least one condition, the at least one check being logically-ORed and at least one of a trap or an exception is generated if none of the at least one condition matches; and
the second bitmask comprises definition of the at least one condition with an additional test that instruction branching is local and the designation of interval defines locality as range within which from Instruction Pointer (fromIP) is included.

13. The processor according to claim 1 wherein the logic operable to execute a control flow integrity instruction includes:
logic operable to execute a control flow assert indirect target from Instruction Pointer (fromIP) instruction wherein the control flow assert indirect target from Instruction Pointer (fromIP) instruction is a target of an indirect branch from IP, otherwise a trap is generated.

14. A processor comprising:
an instruction decoder operable to decode a control flow integrity instruction; and
an execution logic coupled to the instruction decoder and operable to verify changes in control flow and respond to verification failure by at least one of a trap or an exception.

15. The processor according to claim 14 wherein the execution logic comprises:
logic operable to verify changes in control flow comprising one or more conditions of at least one of an instruction length or an instruction alignment.

16. The processor according to claim 14 wherein the execution logic comprises:
logic operable to verify changes in control flow comprising changes resulting from direct branches, indirect branches, direct calls, indirect calls, returns, and exceptions.

17. The processor according to claim 14 wherein:
the instruction decoder is operable to decode the control flow integrity instruction comprising an immediate constant bitmask; and
the execution logic comprises logic operable to define at least one check to be made of at least one condition based on the immediate constant bitmask and logically-ORing the bitmask and generating at least one of a trap or an exception if none of the at least one condition matches,
wherein the immediate constant bitmask comprises bitmask bits operable to identify one or more conditions selected from a group consisting of:
whether the control flow integrity instruction is reachable through sequential execution from a previous instruction;
whether the control flow integrity instruction is a target of an unconditional direct branch;
whether the control flow integrity instruction is a target of a conditional direct branch;
whether the control flow integrity instruction is a target of a non-relative direct branch;
whether the control flow integrity instruction is a target of an indirect branch;
whether the control flow integrity instruction is a target of a relative function call;
whether the control flow integrity instruction is a target of a non-relative or absolute function call;
whether the control flow integrity instruction is a target of an indirect function call; and
whether the control flow integrity instruction is a target of a function return instruction.

18. The processor according to claim 14 wherein:
the instruction decoder is operable to decode the control flow integrity instruction comprising a first immediate constant bitmask and a second bitmask; and
the execution logic comprises logic operable to define at least one check to be made of at least one condition based on the first immediate constant bitmask and logically-ORing the first immediate constant bitmask, and to generate at least one of a trap or an exception if none of the at least one condition matches, the execution logic further operable to define, based on the second bitmask, the at least one condition with an additional test that instruction branching is selected from one or more members of a group consisting of a page marked non-writeable, a page marked execute only, Instruction Pointer (fromIP), local, local with designation of locality defining locality, local with designation of range defining locality, and local with range of locality specified by Instruction Pointer (fromIP).

19. The processor according to claim 14 wherein the execution logic comprises:
logic operable to execute a control flow assert indirect target from Instruction Pointer (fromIP) instruction wherein the control flow assert indirect target from Instruction Pointer (fromIP) instruction is a target of an indirect branch from an IP, otherwise a trap is generated.

20-33. (canceled)

34. A data processing apparatus comprising:
a data security logic operable to use a control flow integrity instruction specified to verify changes in control flow and respond to verification failure by at least one of a trap or an exception.

35. The data processing apparatus according to claim 34 wherein the data security logic comprises:
logic operable to use the control flow integrity instruction in a video gaming server application.

36. The data processing apparatus according to claim 34 wherein the data security logic comprises:
logic operable to use the control flow integrity instruction in a video gaming client application.

37. The data processing apparatus according to claim 34Error! Reference source not found. wherein the data security logic comprises:
logic operable to use the control flow integrity instruction in a copyrighted content anti-piracy application.

38. The data processing apparatus according to claim 34Error! Reference source not found. wherein the data security logic comprises:
logic operable to use the control flow integrity instruction in an information technology server application.

39. The data processing apparatus according to claim 34 wherein the data security logic comprises:
logic operable to use the control flow integrity instruction in an information technology client application.

40. The data processing apparatus according to claim 34 wherein:
the data security logic is operable to execute the control flow integrity instruction specified to verify changes in control flow comprising one or more conditions of at least one of an instruction length or an instruction alignment.

41. The data processing apparatus according to claim 34 wherein:
the control flow integrity instruction is configured to verify changes in control flow comprising changes resulting from direct branches, indirect branches, direct calls, indirect calls, returns, and exceptions.

42. The data processing apparatus according to claim 34 wherein:
the control flow integrity instruction comprises an immediate constant bitmask that defines at least one check to be made of at least one condition, the at least one check being logically-ORed and at least one of a trap or an exception is generated if none of the at least one condition matches.

43. The data processing apparatus according to claim 42 wherein:
the immediate constant bitmask comprises one or more bitmask bits operable to identify one or more conditions selected from a group consisting of:
whether the control flow integrity instruction is reachable through sequential execution from a previous instruction;
whether the control flow integrity instruction is a target of an unconditional direct branch;
whether the control flow integrity instruction is a target of a conditional direct branch;
whether the control flow integrity instruction is a target of a non-relative direct branch;
whether the control flow integrity instruction is a target of an indirect branch;
whether the control flow integrity instruction is a target of a relative function call;
whether the control flow integrity instruction is a target of a non-relative or absolute function call;
whether the control flow integrity instruction is a target of an indirect function call; and
whether the control flow integrity instruction is a target of a function return instruction.

44. The data processing apparatus according to claim 34 wherein:
the control flow integrity instruction comprises a first bitmask, a second bitmask, and a designation of interval;
the first bitmask comprising an immediate constant bitmask that defines at least one check to be made of at least one condition, the at least one check being logically-ORed and at least one of a trap or an exception is generated if none of the at least one condition matches; and
the second bitmask comprising definition of the at least one condition with an additional test that instruction branching is selected from a group consisting of a page marked non-writeable, a page marked execute only, Instruction Pointer (fromIP) of instruction branching matches, local, local with the designation of locality defining locality, local with the designation of range defining locality, and local with the designation of interval defining locality as range within which from Instruction Pointer (fromIP) is included.

45. The data processing apparatus according to claim 34 wherein:
the control flow integrity instruction comprises a control flow assert indirect target from Instruction Pointer (fromIP) instruction wherein the instruction is target of an indirect branch from IP, otherwise a trap is generated.

46-70. (canceled)
